(19) United States
(12) Patent Application Publication
(10) Pub. No.: US 2024/0140546 A1
(43) Pub. Date: May 2, 2024

(54) CONVEYANCE SYSTEM

(71) Applicant: Rivian IP Holdings, LLC, Plymouth, MI (US)

(72) Inventors: Fasil Mulatu Kero, Marietta, GA (US); Travis J. Cook, Bloomfield Hills, MI (US); Omar EL-Qawasmeh, Bloomington, IL (US); Benjamin Jacob Pyne, Bloomington, IL (US)

(21) Appl. No.: 18/050,512

(22) Filed: Oct. 28, 2022

(51) Int. Cl. B62D 65/18; G05D 1/02; H02J 7/00; H02J 9/06

(52) U.S. Cl. CPC B62D 65/18; G05D 1/021; H02J 7/0013; H02J 9/06

(57) ABSTRACT

Disclosed are systems and methods for a system such as a conveyance system. The system can include a conveyor to transport a battery pack for at least a portion of a vehicle. The system can include a connector to electrically couple an energy source of the vehicle with the conveyor. The system can include a voltage converter to convert power from the energy source to operate the conveyor to transport at least the portion of the vehicle.

### INTRODUCTION

A vehicle, such as an electric vehicle, can have various components that can be assembled in an assembly environment.

### SUMMARY

An aspect of this disclosure can be generally directed to a conveyance system or discrete conveyance technology, such as an automated guided vehicle (AGV), a skillet carrier, a vertical articulated carrier (VAC), or any other type of conveyor system, apparatus, or device. While the conveyance system described herein is described with reference to an AGV, the techniques described herein can be applied to any type of conveyance system. The AGV described herein can use a battery pack of a vehicle to power the AGV. The AGV can be powered by the battery pack of the vehicle during assembly of the vehicle. The AGV can use the power of the battery pack to power the AGV as it moves through assembly lines of the assembly environment where the vehicle is being assembled. The present solution allows the vehicle that is being assembled or manufactured to provide power to move or transport itself through the assembly environment by providing power to the AGV. A connector of the AGV can connect to the battery pack. The connector can make power connections and communication connections with the battery pack. A data processing system or battery management system of the AGV can transmit a command to a battery management system of the battery pack to activate the battery pack to provide power from the battery pack to the AGV. At least one voltage converter of the AGV can transform a voltage level of the battery pack from a first voltage level to a second voltage level. For example, the voltage converter can reduce a voltage level of a voltage of the battery pack to a lower voltage level that components of the AGV can consume, use, or operate on.

At least one aspect is directed to a system. The system can include a conveyor to transport a battery pack for a vehicle. The system can include a connector to electrically couple the battery pack with the conveyor. The system can include a voltage converter to convert power from the battery pack to operate the conveyor to assemble at least a portion of the vehicle.

At least one aspect is directed to a method. The method can include receiving, by a connector, power from a battery pack of a vehicle. The method can include converting, by a voltage converter, the power from the battery pack. The method can include operating, by a conveyor, to assemble at least a portion of the vehicle based on the converted power.

At least one aspect is directed to a vehicle. The vehicle can include a frame to carry a battery pack for an automobile. The vehicle can include a connector to electrically couple the battery pack with the vehicle. The vehicle can include a voltage converter to convert power from the battery pack to operate the vehicle to assemble at least a portion of the automobile.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example conveyance system powered by a battery pack of a vehicle being assembled.

FIG. 2 depicts an example AGV that carries the battery pack of the vehicle in FIG. 1.

FIG. 3 depicts an example AGV including a user interface.

FIGS. 4-5 depict an example AGV where a battery pack and at least one motor of an electric vehicle are raised from or located on the AGV.

FIG. 6 depicts an example AGV including a motor to transport the AGV and a drawer to store components of the AGV.

FIG. 7 depicts an example AGV including a drawer extended from the AGV.

FIG. 8 depicts an example AGV included a drawer storing components of the AGV where the drawer is extended from the AGV.

FIG. 9 depict a drawer of an example AGV.

FIG. 10 depicts a disassembled view of an example AGV.

FIG. 11 depicts an example AGV including a frame to carry the battery pack and at least one component of the vehicle of FIG. 1.

FIG. 12 depicts an assembly environment including assembly stations where an AGV carries the battery pack of the vehicle of FIG. 1 to the assembly stations for assembly of the vehicle by people or robotic assemblies.

FIG. 13 depicts an example electric vehicle assembled with a battery pack transported by an AGV.

FIG. 14 depicts an example method of a conveyance system.

FIG. 15 depicts an example method of providing a conveyance system.

FIG. 16 is a block diagram illustrating an architecture for a data processing system that can be employed to implement elements of the systems and methods described and illustrated herein.

FIG. 17 depicts an example VAC powered by a battery pack of a vehicle carried by the VAC from a side view.

FIG. 18 depicts an example VAC powered by an energy source of a product carried by the VAC from a side view.

FIG. 19 depicts an example VAC powered by an energy source of a product carried by the VAC from a front view.

FIG. 20 depicts an example skillet carrier powered by a battery pack of a vehicle carried by the skillet carrier from a side view.

FIG. 21 depicts an example skillet carrier powered by an energy source of a product carried by the skillet carrier from a side view.

FIG. 22 depicts an example skillet carrier powered by an energy source of a product carried by the skillet carrier from a front view.

FIG. 23 depicts an example AGV powered by a battery pack of a vehicle carried by the AGV from a side view.

FIG. 24 depicts an example AGV powered by a battery pack of a product carried by the AGV from a side view.

FIG. 25 depicts an assembly environment where conveyance systems charge at assembly stations.

FIG. 26 depicts an assembly environment where conveyance systems charge at charging infrastructure.

FIG. 27 depicts an assembly environment where conveyance systems are powered based on a battery pack of a vehicle that is being assembled.

### DETAILED DESCRIPTIONS

Following below are more detailed descriptions of various concepts related to, and implementations of, methods, apparatuses, and systems for conveyance systems, such as AGVs. While the conveyance system can be an AGV, the techniques described herein can be applied to any type of conveyance system, such as a slat conveyer, a conveyer belt, a towline conveyer, an overhead conveyer, or a roller conveyer. The techniques described herein can be applied to other types of conveyance systems as well. The various concepts introduced above and discussed in greater detail below may be implemented in any of numerous ways.

An aspect of this disclosure can be generally directed to a conveyance system, such as an AGV. The AGV can transport components of a vehicle as the vehicle is assembled or manufactured in an assembly or manufacturing environment. The AGV can include a battery that needs to be charged frequently, maintained regularly, and replaced periodically. The battery may need to be a high capacity battery to store enough charge to power the AGV as the AGV moves through the assembly environment. Furthermore, in order to frequently charge the batteries of the AGVs, an assembly environment may need backup AGVs so that when one AGV is charging, another AGV can take the place of the charging AGV. Furthermore, the assembly environment may need chargers and charging stations to charge the batteries of the AGVs. The chargers and charging stations can take up space within an assembly or manufacturing environment.

To solve these and other technical challenges, the AGV described herein uses a battery pack of the vehicle whose components are being transported by the AGV during the assembly of the vehicle to power the AGV as the AGV moves through assembly lines of the assembly environment. In this regard, the product that is being manufactured can provide power to move or transport itself through the assembly environment by providing power to the AGV. A connector of the AGV can connect to the battery pack of the vehicle being assembled. The connector can make power connections and communication connections between the battery pack and the AGV. A data processing system or battery management system of the AGV can transmit a command to a battery management system of the battery pack to activate the battery pack and cause contactors of a high voltage distributed box (HVDB) to provide power from the battery pack to the AGV. At least one voltage converter of the AGV can transform a voltage level of the power received from the battery pack from a first voltage level to a second voltage level. For example, the voltage converter can reduce a voltage level of a voltage of the battery pack to a lower voltage level that components of the AGV can consume, use, or operate on. The converted power can be used to power at least one sensor, at least one motor, at least one motor controller, at least one user interface, or at least one system controller of the AGV. The converted power can be used to power other components of the AGV as well.

Furthermore, the AGV can charge an internal backup battery of the AGV. The battery of the AGV can provide backup power when the AGV is disconnected from a battery pack. For example, when the AGV completes the assembly of a vehicle, between the point in time that the AGV disconnects from the battery pack and connects to a new battery pack and activates the new battery pack, the battery of the AGV can provide back-up power to components of the AGV to power the components. In some examples, the internal backup battery can provide backup power to power the AGV when a battery pack connected to the AGV is low on charge or has no charge.

By powering the AGV based on the battery pack of the vehicle being assembled, the AGV can eliminate, or reduce, the need for extra AGVs, charging stations, high capacity internal AGV batteries, or external power sources. Furthermore, this technical solution can save space in an assembly or manufacturing environment since the AGVs do not need chargers or charging stations. Furthermore, the present technical solution can reduce or eliminate charging or charging management for AGVs. Because the AGVs may not need high capacity batteries, a carbon footprint reduction can be realized. Because the AGV may not need its own high capacity battery, the weight, size, and cost of the AGV can be reduced. This technical solution can further reduce an overall length of time to assemble a vehicle since operators or assembly systems may not need to wait for an AGV to charge. Furthermore, this technical solution can reduce a cost of vehicle manufacture or assembly and reduce the length of time for a manufacturing or assembly environment to be constructed.

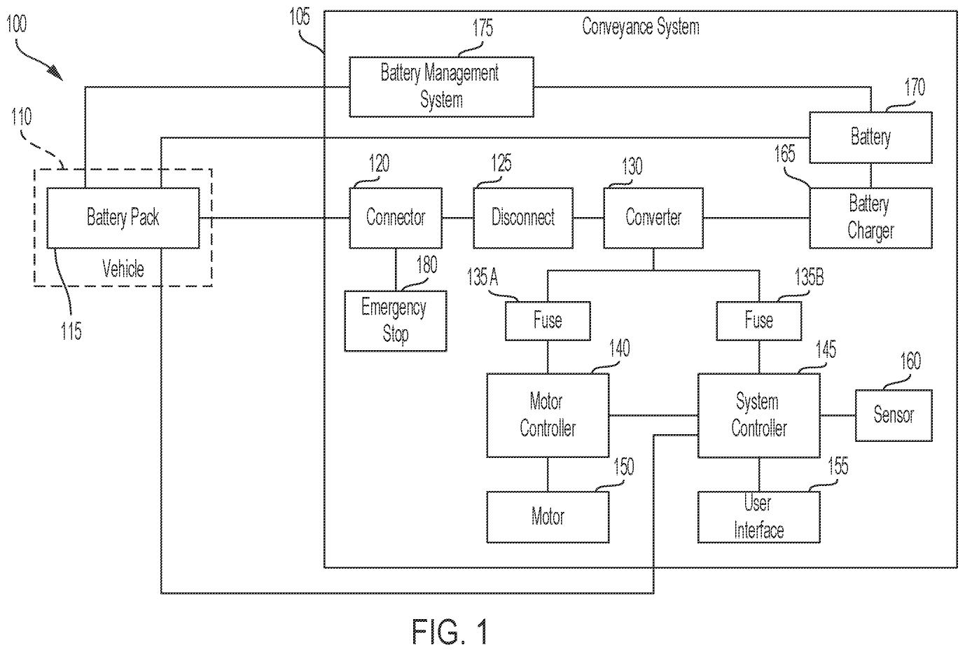

FIG. 1 depicts a system 100 including at least one conveyance system 105 powered by at least one battery pack 115 of at least one vehicle 110 being assembled or manufactured. The conveyance system 105 can be a system that carries, transports, moves, pulls, pushes, conveys or translates the vehicle 110 or components of the vehicle 110. The conveyance system 105 can be a conveyor that conveys the vehicle 110 or components of the vehicle 110 to manufacture or assemble the vehicle 110. The conveyance system 105 can transport the vehicle 110 or components of the vehicle 110 through a manufacturing or assembly environment to assist in the manufacture or assembly of the vehicle 110. For example, the conveyance system 105 can transport the vehicle 110 or components of the vehicle 110 through an assembly line or from assembly station to assembly station where components are added to the vehicle 110 that is under assembly. The conveyance system 105 can be, or include, an AGV, a slat conveyer, a conveyer belt, a towline conveyer, an overhead conveyer, or a roller conveyer. The conveyance system 105 can include other types of conveyance systems.

The vehicle 110 can be an automobile, an aircraft, a boat, or other type of self-propelled apparatus that operates to transport itself or to carry people or goods. The vehicle 110 can be a truck, a sport utility vehicle (SUV), a sedan a coup, a delivery van, a mini-van. The vehicle 110 can be an electric vehicle, a hybrid vehicle, or a combustion engine vehicle. The battery pack or energy source 115 of the vehicle 110 can partially or completely power the vehicle 110 once the vehicle 110 is manufactured. The battery pack 115 can be partially or completely manufactured or assembled before the battery pack 115 is coupled with, connected to, mounted on, or carried by the conveyance system 105. The battery pack 115 can be coupled or connected with the conveyance system 105 after the battery pack 115 is partially or fully charged by a charging system. For example, the battery pack 115 can be 55%-65% charged at the time of connection to the conveyance system 105. In another example, the battery pack 115 can be 50%-70% charged, less than 50% charged, or more than 70% charged.

The battery pack 115 can be loaded onto or coupled to the conveyance system 105. The battery pack 115 can be loaded onto or coupled to the conveyance system 105 at a loading station of a manufacturing or assembly environment. For example, the battery pack 115 can be mounted onto a frame of the conveyance system 105. The battery pack 115 can be connected to a tow line of the conveyance system 105. The battery pack 115 can be set onto a conveyer belt of the conveyance system 105. The conveyance system 105 can connect with the battery pack 115 through at least one connector 120. The connector 120 can be, or include, at least one harness, at least one electrical cable, at least one plug, at least one wireless power transmission component, or any other component that can make electrical connections or wireless electro-magnetic connections between the battery pack 115 and the conveyance system 105. For example, the electrical connections can be power connections, e.g., positive connections, negative connections, ground connections. The electrical connections can be communication connections, e.g., data connections, bus connections, serial connections.

The conveyance system 105 can receive power from the battery pack 115. At least one battery module or battery cell of the battery pack 115 can discharge energy to provide power to the connector 120. For example, the battery pack 115 can provide direct current (DC) power to the connector 120. The battery pack 115 can provide alternative current (AC) power to the connector 120. The battery pack 115 can provide 450V DC to the connector 120. The battery pack 115 can provide 440V DC to 460V DC to the connector 120. The battery pack 115 can provide less than 440V DC. The battery pack 115 can provide more than 460V DC.

The conveyance system 105 can include an emergency stop 180. The emergency stop 180 can be a button, a switch, a lever, or other type of actuatable mechanism. The emergency stop 180 can be, or include, an electrical switch. The electrical switch can complete or break an electrical connection in at least one power connection between the battery pack 115 and the conveyance system 105. The emergency stop 180 can complete or break the electrical connection responsive to an input device of the emergency stop 180 being actuated. For example, if a user actuates the input device, e.g., pushes a button, the electrical connection between the battery pack 115 and the conveyance system 105 can be broken and current can cease to flow or be prevented from flowing from the battery pack 115 to the conveyance system 105 or from the conveyance system 105 to the battery pack 115. In some examples, the emergency stop 180 can break an electrical connection between the connector 120 and a disconnect 125, a converter 130, or another component of the conveyance system 105. The emergency stop 180 can cause the conveyance system 105 to stop moving or apply an emergency brake.

The connector 120 can make at least one electrical connection with the disconnect 125. The connector 120 can provide power from the battery pack 115 to the disconnect 125. The disconnect can be a component that disconnects or connects at least one electrical connection between the connector 120 and at least one converter 130. The disconnect 125 can be a pyro-disconnect, a pyro-fuse, or another disconnecting mechanism to disconnect a high voltage signal (e.g., a 450V signal) between the connector 120 and the converter 130. For example, the disconnect 125 can be or include a fuse or fuse assembly. The disconnect 125 can disconnect at least one power connection between the connector 120 and the converter 130 responsive to a current received by the conveyance system 105 meeting or exceeding a threshold. The disconnect 125 can disconnect at least one power connection between the connector 120 and the converter 130 responsive to a voltage level applied to the conveyance system 105 meeting or exceeding a threshold.

The disconnect 125 can make at least one electrical connection with the converter 130 to provide power from the battery pack 115 to the converter 130. The converter 130 can be a DC to DC converter, an AC to DC converter, a step-down converter, a step-up converter, a half-wave rectifier, a full-wave rectifier, or any other type of device that converts or transforms power in a first format to power in a second format. The converter 130 can step-down, reduce, or lower a first voltage level to a second voltage level. For example, the converter 130 can convert the voltage of the battery pack 115 to a voltage level that at least some components of the conveyance system 105 can operate on or use. The first voltage level can be 450V DC. The first voltage level can be 440V DC to 460V DC. The first voltage level can be less than 440V DC. The second voltage level can be more than 460V DC. The second voltage level can be 24V DC. The second voltage level can be 20V DC to 28V DC. The second voltage level can be less than 20V DC. The second voltage level can be more than 28V DC. The converter 130 can provide the second voltage to at least one component of the conveyance system 105. For example, the converter 130 can provide the second voltage to at least one fuse 135, at least one motor controller 140, at least one motor 150, at least one system controller 145, at least one battery charger 165, at least one battery 170, at least one battery management system 175, at least one sensor 160, at least one user interface 155, or any other component of the conveyance system 105.

The conveyance system 105 can include the fuse 135. The fuse 135 can include a first fuse 135A that makes an electrical connection between the converter 130 and the motor controller 140. The first fuse 135A can be a 20 Amp fuse. The first fuse 135 can be a 18-22 Amp fuse. The first fuse 135A can have an overcurrent level less than 18 Amps. The first fuse 135A can have an overcurrent level more than 22 Amps. The first fuse 135 can break an electrical connection between the converter 130 and the motor controller 140 responsive to a current level provided by the converter 130 to the motor controller 140 exceeding an overcurrent level.

The conveyance system 105 can include a second fuse 135B that makes an electrical connection between the converter 130 and the system controller 145. The second fuse 135 can be a 5 Amp fuse. The second fuse 135B can be a 4-6 Amp fuse. The second fuse 135B can have an overcurrent level less than 4 Amps. The second fuse 135B can have an overcurrent level more than 6 Amps. The second fuse 135B can break an electrical connection between the converter 130 and the system controller 140 responsive to a current level provided by the converter 130 to the system controller 145 exceeding an overcurrent level.

The system controller 145 can be a data processing system such as a programmable controller, a programmable logic controller (PLC), a computer system, or a microcontroller. The system controller 145 can control, communicate with, or provide power to at least one sensor 160 and at least one user interface 155. The conveyance system 105 can include communication connections between the system controller 145 and the sensor 160, the user interface 155, and the motor controller 140. The communication connections can be serial connections, bus connections, parallel data communication connections, wireless communication connections. The system controller 145 can transmit data, data packets, data messages, data frames, data objects, signals, parameters, control settings, operating settings, commands, to the sensor 160, the user interface 155, or the motor controller 140. Furthermore, the system controller 145 can receive data, data packets, data messages, data frames, data objects, measurements, detections, determinations, feedback information, user input, from the sensor 160, the user interface 155, or the motor controller 140.

The conveyance system 105 can include the sensor 160. The sensor 160 can be an area scanner, a camera, an infrared sensor, or an object detection system. The sensor 160 can include other types of sensors. The sensor 160 can detect whether an object, a person, an assembly station, another conveyance system 105, is near, around, in front of the conveyance system 105, behind the conveyance system 105, on a left side of the conveyance system 105, or on a right side of the conveyance system 105. The sensor 160 can detect a distance of the object from the conveyance system 105. The sensor 160 can transmit image data, a sensor measurement, an object detection, an indication of a distance of the object from the conveyance system 105, a size of the object, and other sensed parameters to the system controller 145.

The system controller 145 can execute at least one computer process based on the data received from the sensor 160 to generate a decision for operating the motor 150. For example, the system controller 145 can execute a rule engine, a machine learning model, an artificial intelligence module, a proportional integral derivative (PID) algorithm, a proportional integral (PI) algorithm, a proportional (P) algorithm or any other control process or algorithm. The system controller 145 can identify, based on the data received from the sensor 160, objects around the conveyance system 105 and generate a command to control the motor 150 based on the identifications. For example, the command may be to drive the conveyance system 105 forward to a next assembly station, to stop or brake the conveyance system 105 to avoid an object, to turn the conveyance system 105 left or right to drive the conveyance system 105 to an assembly station or to avoid the object. The conveyance system 105 can transmit the command, a control setting, a control parameter, a piece of data that describes motor operation for the motor 150 to the motor controller 140. The motor 150 can be a DC motor, a separately excited motor, a self-excited motor, a permanent magnet motor, a series wound motor, a compound wound motor, a shunt wound motor. The motor 150, the motor controller 140, or the system controller 145 can be a conveyor, a conveyor apparatus, or components of a conveyor that operate to convey the battery pack 115 or components of the vehicle 110 through a manufacturing or assembly environment to manufacture or assemble the vehicle 110. A conveyor can be a system or a portion of a system. For example, a conveyor can be a system that carriers, moves, conveys, or transports a portion of the vehicle 110 or the battery pack 115. The conveyor can be a portion of the system. The conveyor can hold, support, couple to, or carry the portion of the vehicle 110 or the battery pack 115.

The sensor 160 can detect a line under the conveyance system 105 or along a floor of a ground surface of a manufacturing or assembly environment where the conveyance system 105 is deployed. The sensor 160 can detect whether the conveyance system 105 is following a straight or curved line, is offset in a first direction from the line (e.g., turning right away from the line), is offset in a second direction from the line (e.g., turning left away from the line). The sensor 160 can transmit the readings or detections to the system controller 145. The system controller 145 can make the readings or detections by sensing voltage levels, current levels, or resistance levels of the sensor 160 or other sensor circuits. The system controller 145 can execute a control process based on the detections, measurements, or readings of the sensor 160 to generate a control operation, control setting, motor speed, motor direction, to operate at least one motor 150 with. The system controller 145 can transmit the control operation to the motor controller 140, The motor controller 140 can operate the motor 150 to drive/navigate the conveyance system 105 forward, reverse the conveyance system 105, turn the conveyance system 105, park or brake the conveyance system 105. The motor controller 140 can operate the motor 150 to cause the conveyance system 105 to follow the line on the ground surface.

The conveyance system 105 can include the user interface 155. The user interface 155 can be a human machine interface (HMI). The user interface 155 can be or include a liquid crystal display (LCD), a light emitting diode (LED) display, or an organic led emitting diode (OLED) display. The user interface 155 can be or include a touch screen input, e.g., a resistive touch screen input, a single touch capacitive touch screen, a multi touch capacitive touch screen. The user interface 155 can include, or be associated with, a mouse, a keyboard, a button, a switch, a biometric reader, a camera, or other types of input devices.

The user interface 155 can display a graphic user interface to a user, an operator, an assembly individual, a robot, or other individual or entity. The system controller 145 can generate data and transmit the data to the user interface 155 to cause the user interface to display the data. The system controller 145 can generate data to cause the user interface 155 to display a status of the motor 150, a value of a detection or measurement made by the sensor 160, a station number that the conveyance system 105 is parked at, or other types of information. The user interface 155 can include a user interface element or button for a user to interact with (e.g., press, select, execute, actuate). Responsive to a user interacting with an element of the user interface 155, the user interface can transmit data to the system controller 145 indicating an indication to execute a command. The command can be a command to drive the conveyance system 105 forward, drive the conveyance system 105 in reverse, turn the conveyance system 105, cause the conveyance system 105 to drive to a next assembly station. The system controller 145 can transmit at least one command to the motor controller 140 to operate the motor 150 based on the input received from the user interface 155 to implement the command requested by the user. The system controller 145 can operate the motor 150 based on a variety of controls schemes based on sensor data received from the sensor 160.

The motor controller 140 can be, or include, a controller, microcontroller, data processing system, or a variable frequency drive, to operate at least one motor 150. The motor controller 140 can regulate speed, direction, or torque of the motor 150. The motor controller 140 can apply power to the motor 150 based on the power received from the converter 130. The motor controller 140 can receive control commands or control decisions from the system controller 145 and operate the motor 150 based on the commands or decisions. The motor controller 140 can receive feedback data from the motor 150, e.g., from an encoder, a tachometer, a voltage sensor, a current sensor. The motor controller 140 can execute a motor control process with the feedback data to determine an operation for the motor 150 that implements the control command or decision received from the system controller 145.

The conveyance system 105 can include at least one battery charger 165. The battery charger 165 can be or include at least one converter, switch, controller (e.g., a microcontroller, an application specific integrated circuit (ASIC), control circuit). In some examples, the battery charger 165 and the converter are separate components and in some examples, the battery charger 165 and the converter are combined. The converter of the battery charger 165 can convert power from a second level received from the converter 130 to a third level. The converter of the battery charger 165 can be a second converter of the conveyance system 105. For example, a converter or converter system of the conveyance system 105 can include a first converter 130 to convert a first voltage to a second voltage level to power a first component of the conveyance system 105. The converter or converter system of the conveyance system 105 can include a second converter of the battery charger 165 that converts the second voltage level to a third voltage level to power another component of the conveyance system 105.

The converter of the battery charger 165 can reduce a voltage level received from the converter 130. The converter of the battery charger 165 can convert a received voltage level and provide the converted voltage level to a component of the conveyance system 105 for the conveyance system 105 to use, e.g., to charge the battery 170. For example, the converter of the battery charger 165 can convert power from 24V DC to 12V DC. The input voltage of the converter of the battery charger 165 can be 22-26V DC, 20-28V DC, less than 22V, or more than 28V. The output voltage of the converter of the battery charger 165 can be 10-14V DC, 8-16V DC, less than 8V DC, or more than 16V DC. The controller can operate the switches to charge the battery 170, e.g., cause current from the converter 130 to be provided to the battery 170, control a level of current received from the converter 130 and applied to the battery 170, control a voltage level of a output by the converter 130 and apply the voltage to the battery 170. The battery 170 can be a 10V-14V battery. The battery 170 can be a 9V-15V battery, the battery 170 can have a voltage greater than 15V. The battery 170 can have a voltage less than 9V. The battery 170 can be a 12V battery. The battery 170 can be a prismatic battery, a cylindrical batter, a pouch battery.

The controller can operate the switches to cause the battery 170 to discharge energy and provide power to components of the conveyance system 105. For example, the battery 170 can provide backup power to the components of the conveyance system 105. For example, when the battery pack 115 is detached from, disconnected from, or removed from the conveyance system 105, the battery 170 can power the components of the conveyance system 105. Furthermore, when the battery pack 115 is completely or partially discharged and still connected to the conveyance system 105, the battery 170 can power the components of the conveyance system 105. For example, the battery 170 can power at least one battery management system 175, power the system controller 145, power the user interface 155, power the sensor 160, power the motor controller 140.

The battery management system 175 can be powered by power from the converter 130 or power received from the battery 170. The battery management system 175 can transmit data, data packets, data frames, data elements, or other pieces of information to the battery pack 115 (or a battery management system of the battery pack 115). The battery management system 175 can monitor the battery pack 115. The battery management system 175 can transmit a command or request to activate the battery pack 115 to provide power to the conveyance system 105. Responsive to receiving the command or request from the battery management system 175, the battery pack 115 can provide, transmit, convey, or sync power to the connector 120 of the conveyance system 105. Because the battery pack 115 may not be configured to provide power to the conveyance system 105 without receiving an activation command, the battery management system 175 operates on backup power received from the battery 170 when a battery pack 115 is first connected with the conveyance system 105.

The conveyance system 105 can carry one or more battery packs or draw power from one or more battery packs at a time through an assembly or manufacturing environment. For example, the conveyance system 105 can sequentially carry battery packs 115. For example, the conveyance system 105 can receive and carry a first battery pack 115 until the vehicle 110 is completely assembled, reaches a particular level of assembly, or until the first battery pack 115 is removed from the conveyance system 105 for installation in the vehicle 110. The conveyance system 105 can receive a second battery pack 115 after the first battery pack 115 is removed from the conveyance system 105. In some examples, as soon as the second battery pack 115 is connected to the conveyance system 105, the second battery pack 115 can begin providing power to the conveyance system 105. However, in some examples, because the second battery pack 115 may not automatically provide power to the conveyance system 105 responsive to the second battery pack 115 being connected to the conveyance system 105 via the connector 120, the battery management system 175 can operate based on backup power received from the battery 170. The battery management system 175 can transmit the command to activate the second battery pack 115 based on the backup power provided by the battery 170. The backup power provided by the battery 170 can be based on power received from the first battery pack 115 when the first battery pack 115 was connected to the conveyance system 105.

The electrical connections between the battery pack 115 and the connector 120, the connector 120 and the disconnect 125, the disconnect 125 and the converter 130, and the connector 120 and the emergency stop 180 can be at a first voltage. The first voltage can be 450V DC. The electrical connections between the converter 130 and the fuses 135, the fuse 135A and the motor controller 140, the motor controller 140 and the motor 150, the fuse 135B and the system controller 145, and the converter 130 and the battery charger 165 can be a second voltage. The second voltage can be less than the first voltage. The second voltage can be 24V DC. The electrical connections between the battery charger 165 and the battery 170, the battery 170 and the battery management system 175, and the battery 170 and the battery pack 115 can be a third voltage. The third voltage can be less than the second voltage. The third voltage can be 12V DC. The battery 170 can provide a voltage to the battery pack 115 to power the battery pack 115 so that the battery pack 115 can be activated. The electrical connections between the system controller 145 and the sensor 160, the system controller 145 and the motor controller 140, the system controller 145 and the user interface 155, the system controller 145 and the battery pack 115, and the battery management system 175 and the battery pack 115 can be communication connections. The communication connections can be bidirectional communication connections, transmit connections, receive connections, bus connections, serial connections, or any other type of connection for transmitting or receiving data. The conveyance system 105 can include any other or additional components.

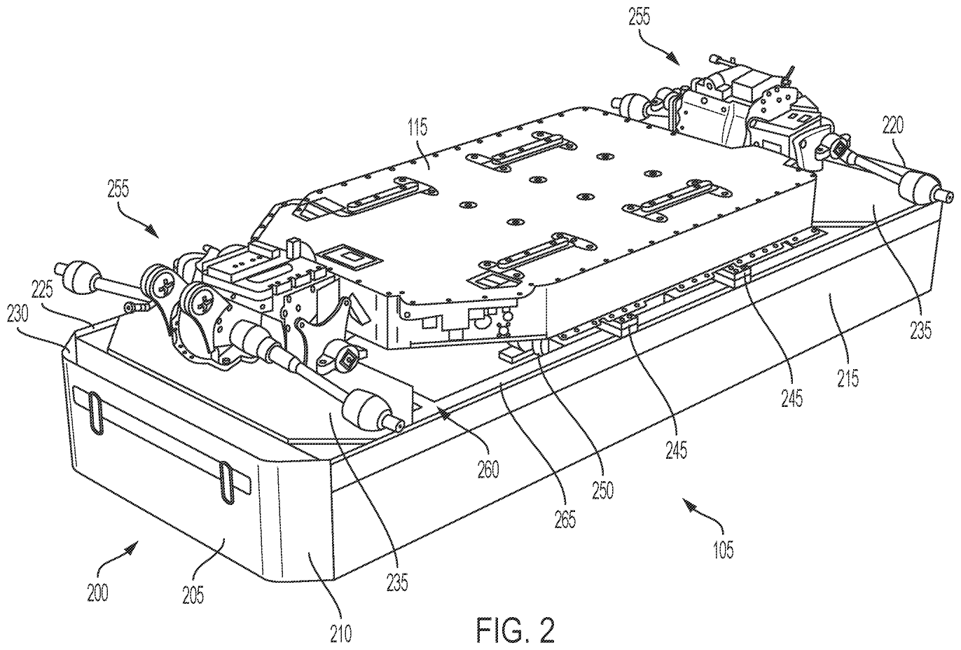

FIG. 2 depicts an example conveyance system 105, such as an AGV, that carries a battery pack 115 of a vehicle 110. The conveyance system 105 can include a frame 260. The frame 260 can be or include supports that bears, carries, or supports the weight of the conveyance system 105. The frame 260 can be a conveyor, a conveyor apparatus, or a component of a conveyor that conveys the battery pack 115 or components of the vehicle 110 through an assembly or manufacturing environment. Furthermore, the frame 260 can include at least one component or member 265. The member 265 can be a linkage, a bar, a beam, an elongated member, a structural member, or a support member. The members 265 can form the frame 260. The frame 260 can be 200 inches to 250 inches long. The frame 260 can be 190 inches to 260 inches long. The frame 260 can be less than 190 inches. The frame 260 can be more than 260 inches long. The frame 260 can be 70 inches to 80 inches long. The frame 260 can be 65 to 85 inches long. The frame 260 can be less than 65 inches long. The frame 260 can be more than 85 inches long. The frame 260 can be 6 inches to 12 inches thick. The frame 260 can be 4 inches to 14 inches thick. The frame 260 can be less than 4 inches thick. The frame 260 can be more than 14 inches thick. The members 265 of the frame 260 can be aluminum, steel, carbon fiber, or other suitable material. The members 265 of the frame 260 can support a weight of 2 tons to 3 tons. The members 265 of the frame 260 can support a weight of 1 ton to 4 tons. The members 265 of the frame 260 can support a weight less than 1 ton. The members 265 of the frame 260 can support a weight less than 4 tons or other weight limits.

At least one tractive component 250 can be coupled, fixedly coupled, fixed, attached, or connected to a first or bottom side 600 of the frame 260. For example, the tractive component 250 can be fixed to the member 265 of the frame 260. The tractive component 250 can be driven by the motor 150 of the conveyance system 105. The tractive component 250 can actuate based on momentum or motion of the conveyance system 105. The tractive component 250 can be a wheel, a tire, a pulley system, a tread, a winch, a conveyor. The tractive component 250 can be a conveyor, a conveyor apparatus, or a component of a conveyor that operate to convey the battery pack 115 or components of the vehicle 110 through a manufacturing or assembly environment to manufacture or assemble the vehicle 110. The battery pack 115 can be coupled, fixedly coupled, fixed, attached, or connected to a second or top side of the frame 260, as seen in FIG. 2. The battery pack 115 can be secured, stowed, or connected to the top side of the frame 260 via a gravitational force, a frictional force, or a component 245. The component 245 can secure the battery pack 115 to the frame 260 while the conveyance system 105 transports, translates, moves, is pulled, is pushed, or drives. The battery pack 115 can connect to the conveyance system 105 in a variety of manners.

At least one platform 235 can be coupled, fixed, frictionally attached, or connected to the top surface of the frame 260. The battery pack 115 can be placed on the top surface of the frame 260 between a first platform and second platform 235. The first and second platforms 235 can be octagonal shaped platforms, rectangular platforms, diamond shaped platforms, triangular shaped platforms, hexagonal shaped platforms, or assume other shapes. The first and second platforms 235 can be 3 inches to 4 inches thick. The first and second platforms 235 can be 1 inch to 6 inches thick. The platforms 254 can be more than 6 inches thick. The platforms 254 can be less than 1 inch thick or assume other configurations.

Vehicle components 255 can be placed onto the first and second platforms 235. Manufacturing equipment, robot assembly units, assembly personnel, manufacturing individuals, can assemble, build, or construct the vehicle components 255 while the vehicle components 255 are stowed on the first or second platforms 235. The vehicle components 255 can be a front motor of the vehicle 110, a rear motor of the vehicle 110, a front suspension system of the vehicle 110, a rear suspension system of the vehicle 110, an axle of the vehicle 110, springs of the vehicle 110, shock absorbers of the vehicle 110, rods of the vehicle 110, joints of the vehicle 110, bearings of the vehicle 110, bushings of the vehicle 110, a break system of the vehicle 110, a rotor of the vehicle 110, a caliper of the vehicle 110, a break pad of the vehicle 110, or other vehicle components. The first and second platforms 235 can each carry a single motor, e.g., a dual motor that drives two front wheels or two rear wheels. The first and second platforms 235 can each carry two motors. The motors can be quad motors where each motor drives an individual wheel of the vehicle 110.

The conveyance system 105 can include a housing 200. The housing 200 can surround an outer side of the conveyance system 105. The housing 200 can be made of, or include, plastic, fiber glass, carbon fiber, aluminum, or other suitable material. The housing 200 can surround the frame 260, the tractive component 250, the disconnect 125, the converter 130, the fuses 135, the motor controller 140, the motor 150, the system controller 145, the sensors 160, the battery charger 165, the battery 170, the battery management system 175, or other components of the conveyance system 105. The housing 200 can be coupled to the frame 260. The housing 200 can be coupled to the frame 260 via at least one bolt, at least one screw, at least one connector, at least one weld, or other connecting mechanisms.

The housing 200 can include a front or first lateral wall 205 and a rear or second lateral wall 220. The front lateral wall 205 and the rear lateral wall 220 can be parallel. The housing 200 can include a third lateral wall 225 and a fourth lateral wall 215. The third lateral wall 225 and the fourth lateral wall 215 can be parallel. The front lateral wall 205 and the rear lateral wall 220 can each be perpendicular to third lateral wall 225 and the fourth lateral wall 215. The conveyance system 105 can assume a variety of shapes and sizes. The housing 200 can include oblique sections 210 and 230. The oblique section 210 can extend from the first lateral wall 205 to the fourth lateral wall 215. The oblique section 230 can extend from the first lateral wall 205 to the third lateral wall 225. Two oblique sections can connect the second lateral wall 220 to the third lateral wall 225 and the fourth lateral wall 215.

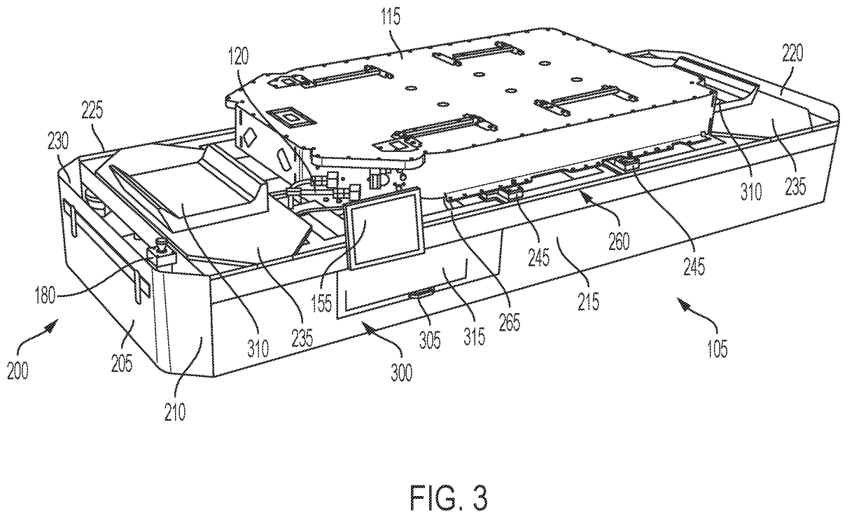

FIG. 3 depicts an example conveyance system 105, such as an AGV, including the user interface 155. The user interface 155 can be fixed to the member 265 of the frame 260. The user interface 155 can extend above the frame 260. The user interface 155 can extend towards the ground surface under the conveyance system 105 past a top surface, edge, or boundary of the housing 200 on an outer side of the housing 200. The emergency stop 180 can be fixed to the member 265 of the frame 260. The emergency stop 180, or a button of the emergency stop 180, can extend away from a surface under the conveyance system 105 above a top surface, top edge, or top boundary of the housing 200 to be accessible by an assembly individual, an assembly individual, or a user.

The conveyance system 105 can include at least one saddle 310. The saddle 310 can be a u-shaped component that secures the motors 255 to the conveyance system 105. The motors 255 can fit within the saddle 310. For example, the saddle 310 can include a flat section that the motor 255 rests upon between a first protrusion of the saddle 310 that extends up away from a surface under the conveyance system 105 and a second protrusion of the saddle 310 that extends up away from a surface under the conveyance system 105.

The conveyance system 105 includes a drawer 300. The drawer can include a handle 305. A user can pull on the handle 305 to extend or deploy the drawer 300 from the housing 200. The user can push on the handle 305 or an end surface 315 of the drawer 300 to retract or stow the drawer 300 within the conveyance system 105. The housing 200 can include an opening that the drawer 300 extends from or retracts into. The opening of the housing 200 and the end surface 315 can have the same shape, e.g., rectangular, square, circular, oval shaped, triangular. The boundaries, edges, or ends of the surface 315 can extend to or beyond boundaries, edges, or ends of the opening of the housing 200 such that the end surface 315 completely covers the opening of the housing 200, overlaps the housing 200, or forms a flush surface with the lateral wall 215 of the housing 200.

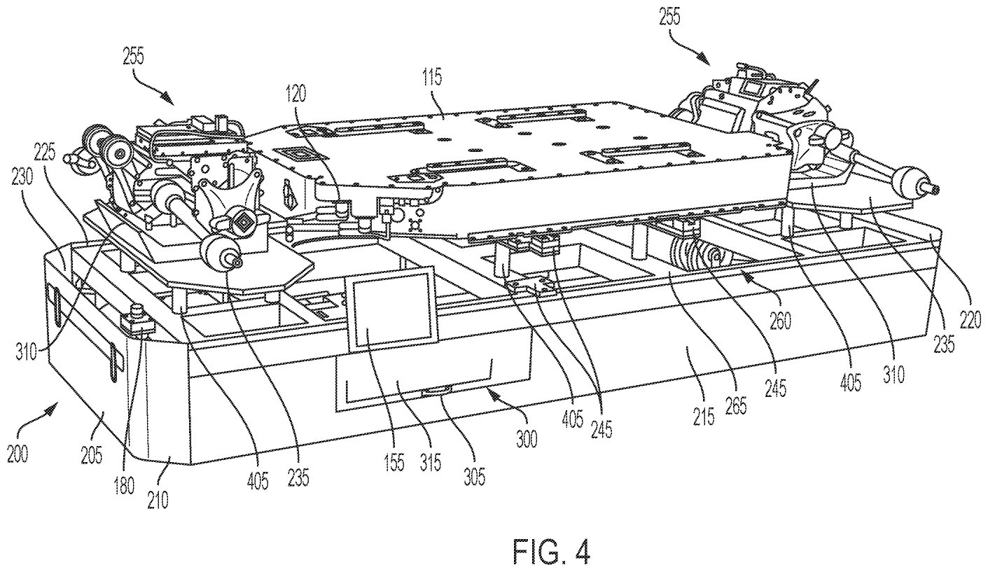

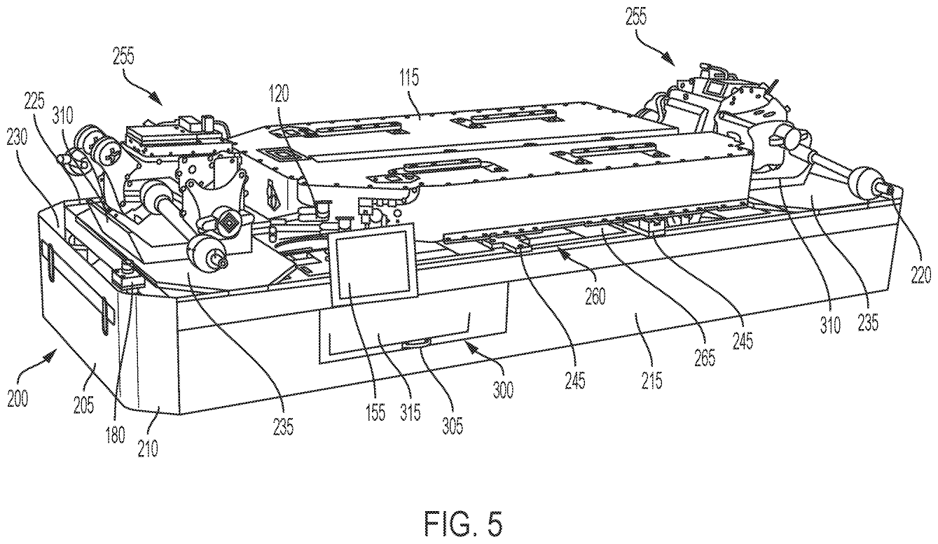

FIGS. 4-5 depicts an example conveyance system 105, such as an AGV, where the battery pack 115 and the motors 255 of an electric vehicle are lifted from and placed onto the conveyance system 105. The first and second platforms 235 can include at least one protrusion 405. The protrusion 405 can extend from a bottom surface of the first and second platform 235 towards a ground surface under the conveyance system 105. The protrusion 405 can extend from a bottom surface of the first or second platform 235 to a ground surface under the conveyance system 105 in a direction perpendicular to the bottom surface of the first and second platform 235. The protrusions 405 can be pegs, cylindrical components, rectangular solid shaped components, cube shaped components, pins. The protrusions 405 can fit within slots of the frame 260. The protrusions 405 can have a shape that corresponds to the shape of the slots. For example, if the protrusion 405 is a cylindrical shaped protrusion, the slot can have a circular opening or include a cylindrical cavity. The openings of the frame 260 can be slightly larger than, or the same size as, the protrusion 405 to allow the protrusion 405 to extend into the opening. The openings can control, limit, or prevent movement of the first and second platforms 235.

Furthermore, the battery pack 115 can be mounted to a sled, platform, or other surface that includes protrusions 405. The protrusions of the platform of the battery pack 115 can fit within slots of the frame 260 to the control, limit, or prevent movement of the platform of the battery pack 115. Furthermore, a first portion of the component 245 can be fixed to the frame 260 and a second portion of the component 245 can be fixed to the battery pack 115 or a platform that the battery pack 115 sits on. The first portion of the component 245 can be fixed to the frame 260 via at least one of a bolt, a nut, a screw, a nail, a connector, a weld, an adhesive. The second portion of the component 245 can be fixed to the battery pack 115 or to a platform that the battery pack 115 sits on via at least one of a bolt, a nut, a screw, a nail, a connector, a weld, an adhesive. The first portion of component 245 and the second portion of the component 245 can be coupled, fixed, or connected together. The first portion of the component 245 and the second portion of the component 245 can be coupled via a screw, a bolt, a nut, a nail, a connector, a weld, an adhesive. The first portion and the second portion of the component 245 can fix the battery pack 115 to the conveyance system 105 and limit, prevent, stop, or control movement of the battery pack 115. For example, when the conveyance system 105 moves forward, reverse, or turns, the component 245 can keep the battery pack 115 fixed to the top surface of the frame 260.

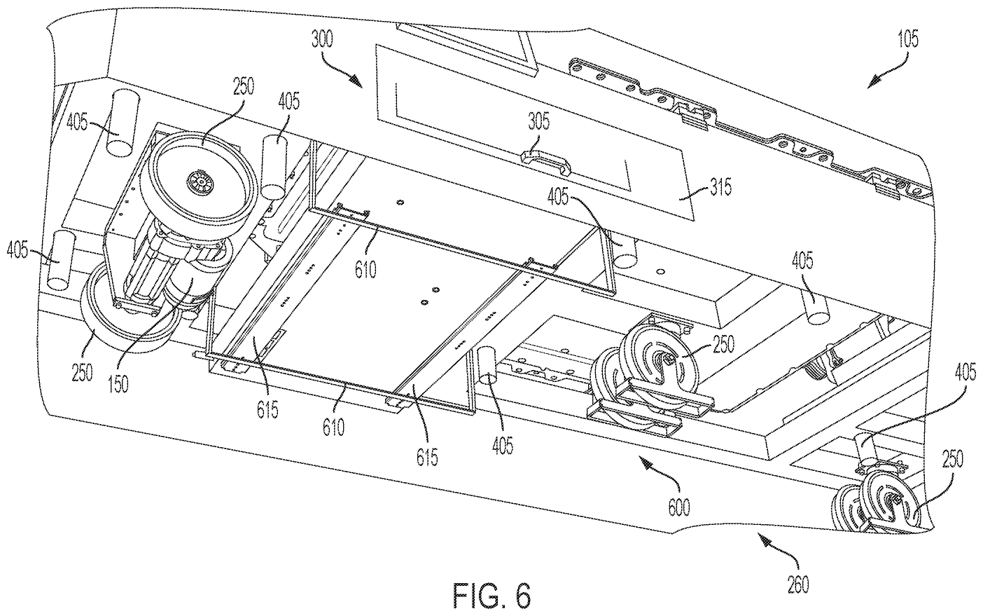

FIG. 6 depicts an example conveyance system 105, such as an AGV, including the motor 150 to transport the conveyance system 105 and the drawer 300 to store components of the conveyance system 105. The drawer 300 includes at least one rail 615. The rail can be a telescoping assembly where a first portion of the rail 615 is coupled to a second portion of the rail 615 and the first portion of the rail 615 extends from, or retracts back into, the second portion of the rail 615. The first portion of the rail 615 can be fixed to a bottom surface 620 of the drawer 300. The second portion of the rail 615 can be fixed to at least one bracket 610. The brackets 610 can be u-shaped brackets can extend from the frame 260 down towards a ground surface under the conveyance system 105. The brackets 610 can connect to the frame 260 in two locations, extend perpendicular from the frame 260 down towards the ground surface under the conveyance system 105, and be joined by a lateral portion that connects ends of the two portions. The rails 615 can be coupled to the lateral portion of the brackets 610 and can be supported by the brackets 610.

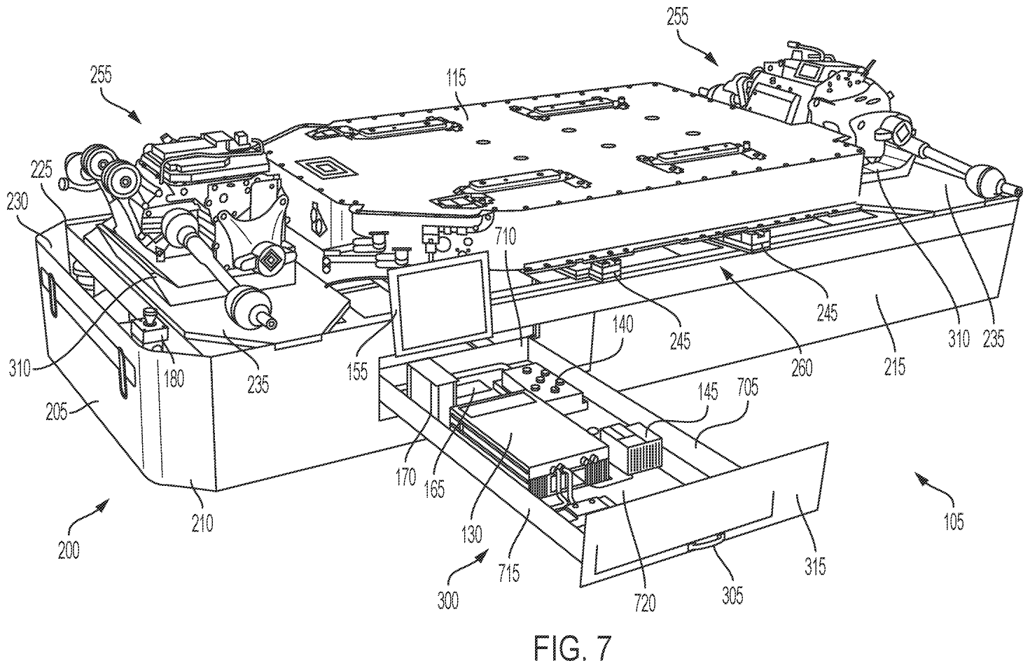

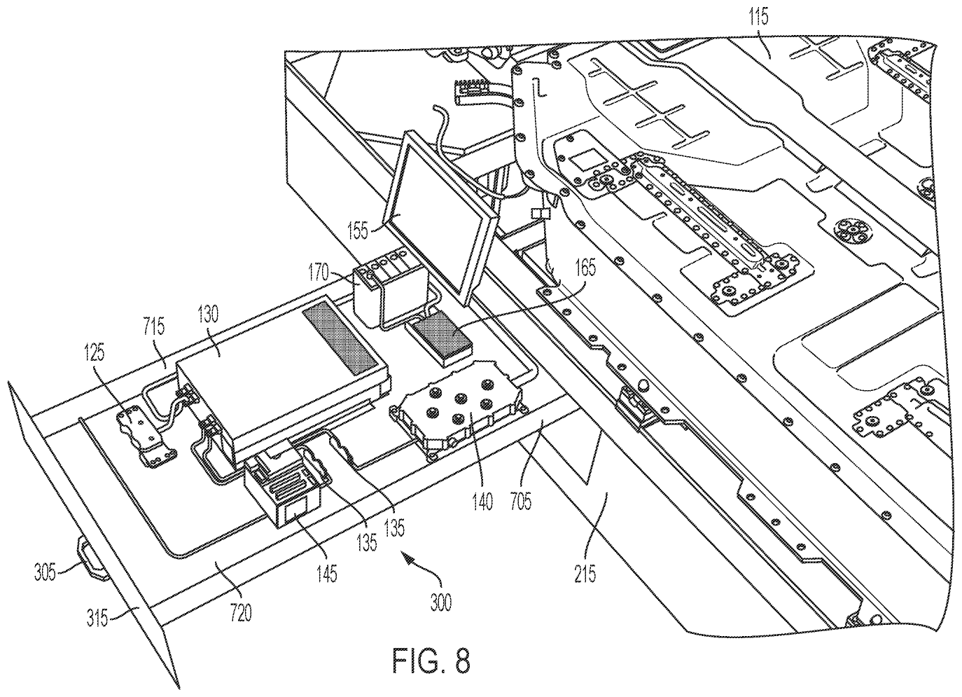

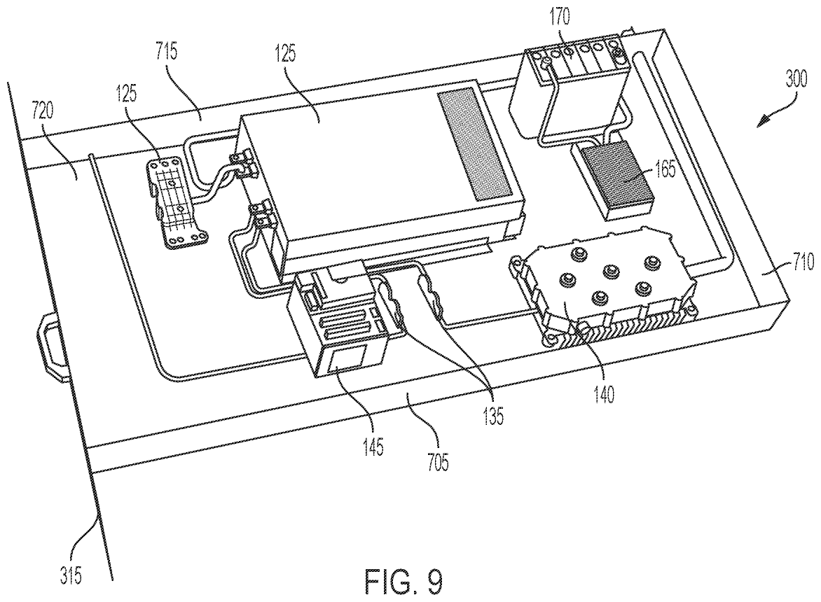

FIGS. 7-9 depict an example drawer 300 of a conveyance system 105, such as an AGV, having AGV components therein. The drawer 300 includes a first lateral wall 705, a second lateral wall 715, a third lateral wall 710, and a bottom 720. The lateral wall 705 and the lateral wall 715 can extend from the third lateral wall 710 to the surface 720. The first lateral wall 705 and the second lateral wall 715 can extend from the third lateral wall 710 to the end surface 315 in a direction perpendicular to the lateral wall 215 of the housing 200. The first lateral wall 705, the second lateral wall 715, and the third lateral wall 710 can extend up from the bottom 720 a distance. The surface 315 can extend a distance below a lower edge, boundary, or surface of the lateral wall 715 and the lateral wall 705 in a direction parallel to the lateral wall 215. The surface 315 can extend above a top edge, top boundary, or top surface of the lateral wall 715 and the lateral wall 705. The drawer 300 can have a variety of shapes, sizes, and configurations. One or more components can be placed inside the drawer 300, on the frame 200 of the conveyance system 105, or on a platform of the conveyance system 105.

At least one electrical, mechanical, or electromechanical component of the conveyance system 105 can be stored in the drawer 300. However, the various electrical, mechanical, or electromechanical components can be located outside the drawer 300 in a variety of locations of the conveyance system 105. The conveyance system 105 may not include a drawer and may store the components on, under, within, or on a side of the conveyance system 105. For example, at least a portion of the connector 120 can be stored within the drawer 300. For example, at least a one disconnect 125, at least one converter 130, at least one battery charger 165, at least one battery 170, at least one battery management system 175, at least one motor controller 140, at least one motor 150, at least one system controller 145, at least one sensor 160, or at least one user interface 155 can be stored within the drawer 300. The components of the conveyance system 105 can be coupled to a surface of the bottom 720 of the drawer 300. For example, the conveyance system 105 can be coupled to a top surface of the bottom 720 of the drawer 300. The components of the conveyance system 105 can be frictionally fixed to the top surface of bottom 720 of the drawer 300 via a gravitational force. The components of the conveyance system 105 can be fixed to the top surface of the bottom 720 of the drawer 300 by at least one bolt, at least one nut, at least one washer, at least one connector, an adhesive, a weld.

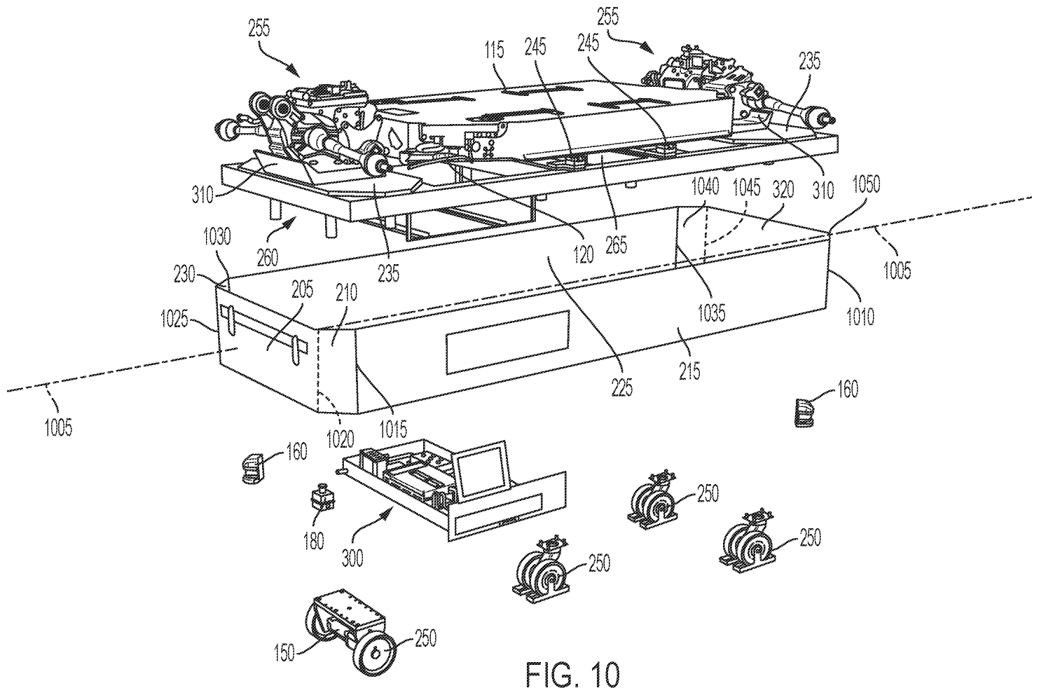

FIG. 10 depicts a disassembled view of an example conveyance system 105, such as an AGV. The conveyance system 105 can travel forward or reverse along a longitudinal axis 1005 of the conveyance system 105. The conveyance system 105 can travel from assembly station to assembly station in a direction along the longitudinal axis 1005 of the conveyance system 105. The longitudinal axis 1005 can run the length of the conveyance system 105. The longitudinal axis 1005 can extend from a center point from the lateral wall 320 to a center point of the lateral wall 205.

The lateral wall 215 can extend from a first edge, boundary, or portion 1010 in a direction parallel to the longitudinal axis 1005 to a second edge, boundary, or portion 1015. The first edge 1010 can be perpendicular to the longitudinal axis 1005. The second edge 1015 can be perpendicular to the longitudinal axis 1005. The first edge 1010 can define an edge where the lateral wall 215 meets an oblique portion that extends from the edge 1010 to the lateral wall 320. The second edge 1015 can define an edge where the lateral wall 215 meets an oblique section 210.

The oblique section 210 can extend in a direction at an angle oblique or acute to the longitudinal axis 1005 from the boundary 1015 to a boundary, edge, or portion 1020 of the lateral wall 205. The lateral wall 205 can extend in a direction perpendicular to the longitudinal axis 1005 from the boundary 1020 of the lateral wall 205 to a boundary, edge, or portion 1025 of the lateral wall 205 that couples, meets, or joins the lateral wall 205 to the oblique section 230. The oblique section 230 can extend at an angle oblique or acute to the longitudinal axis 1005 from the boundary 1025 to a boundary 1030 of the lateral wall 225. The lateral wall 225 can extend from the boundary 1030 in a direction parallel to the longitudinal axis 1005 to a boundary, edge, or portion 1035 of the lateral wall 225. The oblique portion 1040 can extend from the boundary 1035 at an angle oblique to the longitudinal axis 1005 to a boundary 1045 of the lateral wall 320. The lateral wall 320 can extend from the boundary 1045 to the boundary 1050 in a direction perpendicular to the longitudinal axis 1005.

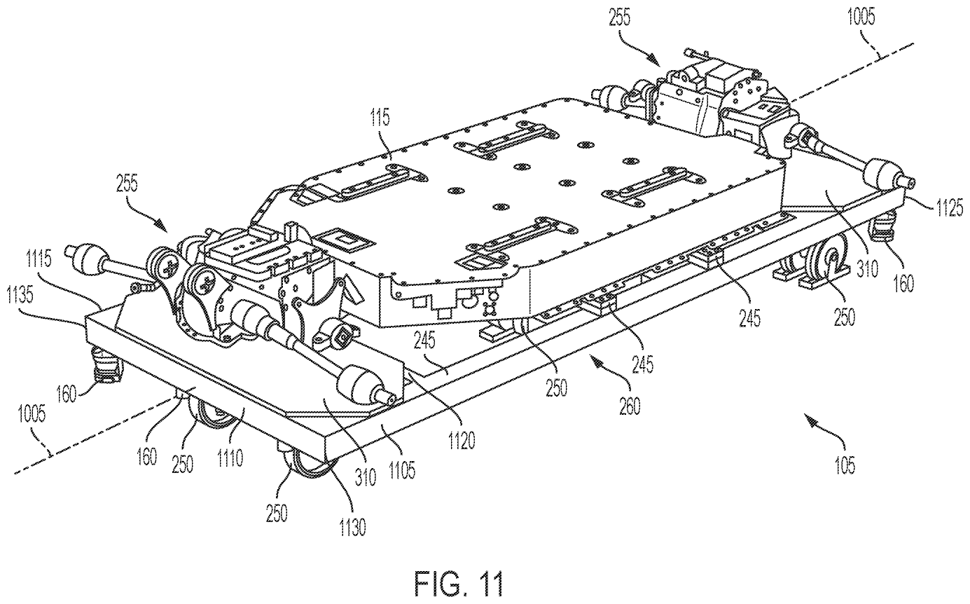

FIG. 11 depicts an example conveyance system 105, such as an AGV, including the frame 260 to carry the battery pack 115 and at least one component 255 of the vehicle 110. The conveyance system 105 of FIG. 11 depicts an example of the frame 260 when the housing 200 is removed. The frame 260 can be made up of various members 265, such as a member 1105, a member 1110, a member 1115, a member 1120, an various other members. The member 1105 can extend from a boundary, edge, portion, or corner 1125 in a direction parallel to the longitudinal axis 1005 to a boundary, edge, portion, or corner 1130. A member 1110 can extend from the corner 1130 in a direction perpendicular to the longitudinal axis 1005 to a boundary, edge, portion, or corner 1135. The member 1110 can form a front side of the conveyance system 105.

The member 1115 can extend from the corner 1135 in a direction parallel to the longitudinal axis 1005. The direction can extend backwards relative to a forward direction of movement of the conveyance system 105. The member 1115 can extend to a boundary, edge, portion, or corner. The corner can be located behind the battery pack 115 or the motor 255 and is not shown in FIG. 11. A member can extend from the corner not shown in FIG. 11 in a direction perpendicular to the longitudinal axis 1005 to the corner 1125. The member can form a rear portion or back of the conveyance system 105. At least one member 1120 can extend in a directional perpendicular to the longitudinal axis 1005 from the member 1105 to the member 1115.

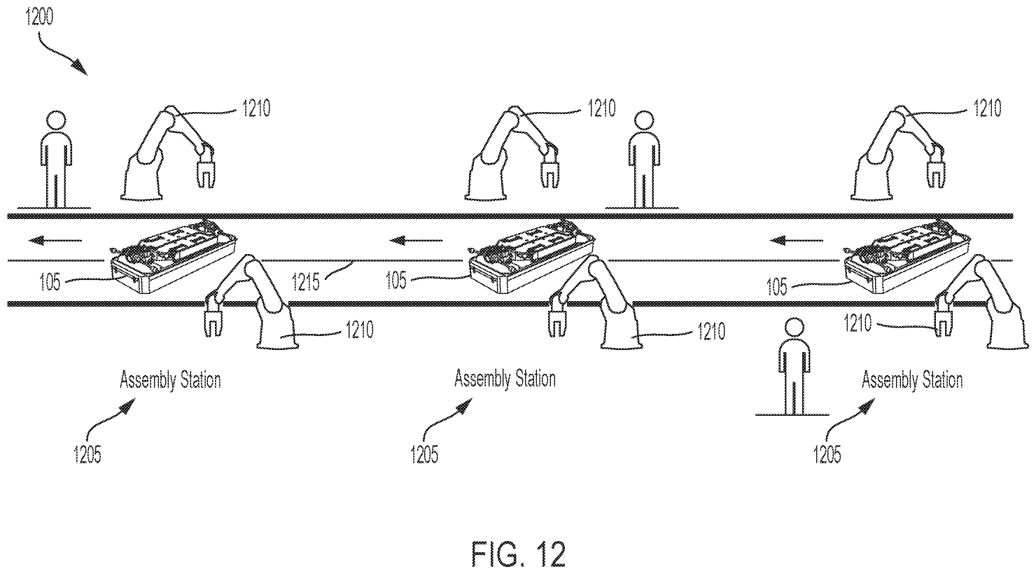

FIG. 12 depicts an assembly environment 1200 including assembly stations 1205 that a conveyance system 105, such as an AGV, carries a battery pack of a vehicle 110 to for assembly of the vehicle 110. The environment 1200 can be a manufacturing environment, an assembly environment, a maintenance environment, an inspection action, a mechanics garage, a warehouse, a factory, a service center, or any other building, buildings, space, or spaces defined by boundaries, walls, roofs, a ground floors, levels. At each station 1205, at least one assembly action, manufacturing operation, maintenance action, cleaning action, or inspection action can be performed. For example, at each station 1205 a new component can be added to the vehicle 110 in construction. In addition to adding a new component, or instead of adding a new component, at a station 1205 two or more components carried by the conveyance system 105 can be connected, inspected, programmed, or configured. At one or multiple stations 1205, a robotic assembly system 1210 can perform the assembly action. Furthermore, at least one maintenance individual, can perform the assembly action at the stations 1205.

For example, at each station 1205, a new component can be added or installed on the battery pack 115 or the vehicle component 255. For example, at a first station 1205, the conveyance system 105 can receive at least one motor. The conveyance system 105 can drive from the first station 1205 to at least one second station 1205. At the at least one second station 1205, a suspension system can be installed with the motor. After the at least one second station 1205, the conveyance system 105 can drive to at least one third station 1205. At a third station 1205, rotors, calipers, or brakes can be installed. A line 1215 can be painted, drawn, printed, or fixed to a ground surface of the environment 1200. At least one sensor of the conveyance system 105 can detect the line 1215 and follow the line 1215 from assembly station 1205 to assembly station 1205. The conveyance system 105 can be continuously powered as the conveyance system 105 moves through the assembly stations 1205.

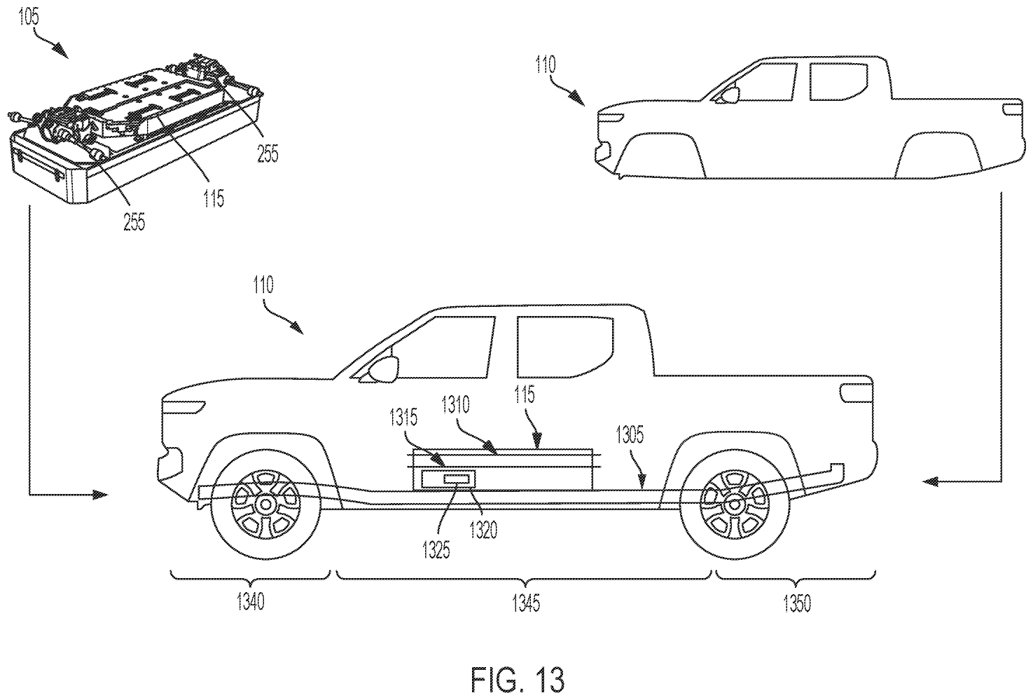

FIG. 13 depicts an example cross-sectional view of an electric vehicle 110 installed with the battery pack 115. The electric vehicle 110 can be or include an electric truck, an electric sport utility vehicle (SUV), an electric delivery van, an electric automobile, an electric car, an electric motorcycle, an electric scooter, an electric passenger vehicle, an electric passenger or commercial truck, a hybrid vehicle, or other vehicles such as a sea or air transport vehicle, plane, helicopter, submarine, boat, or drone, among other possibilities. The battery pack 115 can also be used as an energy storage system to power a building, such as a residential home or commercial building. The electric vehicle 110 can be fully electric or partially electric (e.g., plug-in hybrid) and further, the electric vehicle 110 can be fully autonomous, partially autonomous, or unmanned. The electric vehicle 110 can also be human operated or non-autonomous. The electric vehicle 110 such as electric trucks or automobiles can include on-board battery packs 115, batteries or battery modules 1320, or battery cells 1325 to power the electric vehicle 110.

The electric vehicle 110 can include a chassis 1305 (e.g., a frame, internal frame, or support structure). The chassis 1305 can support various components of the electric vehicle 110. The chassis 1305 can span a front portion 1340 (e.g., a hood or bonnet portion), a body portion 1345, and a rear portion 1350 (e.g., a trunk, payload, or boot portion) of the electric vehicle 110. The battery pack 115 can be installed or placed within the electric vehicle 110. For example, the battery pack 115 can be installed on the chassis 1305 of the electric vehicle 110 within one or more of the front portion 1340, the body portion 1345, or the rear portion 1350. The battery pack 115 can include or connect with at least one busbar, e.g., a current collector element. For example, the first busbar 1310 and the second busbar 1315 can include electrically conductive material to connect or otherwise electrically couple the battery pack 115, the battery modules 1320, or the battery cells 1325 with other electrical components of the electric vehicle 110 to provide electrical power to various systems or components of the electric vehicle 110.

At one stage during the manufacturing or assembly of the vehicle 110, the battery pack 115 and components 255 carried by the conveyance system 105 can be installed with other components of the vehicle 110. For example, the battery pack 115 and the components 255 can be removed from the conveyance system 105 and combined with a chassis 1305 of the vehicle 110 and connected with other components of the vehicle 110. For example, a body of the vehicle 110 can be raised over the battery pack 115 and the suspension system 255 of the vehicle 110 and placed over the battery pack 115 and the suspension system 255.

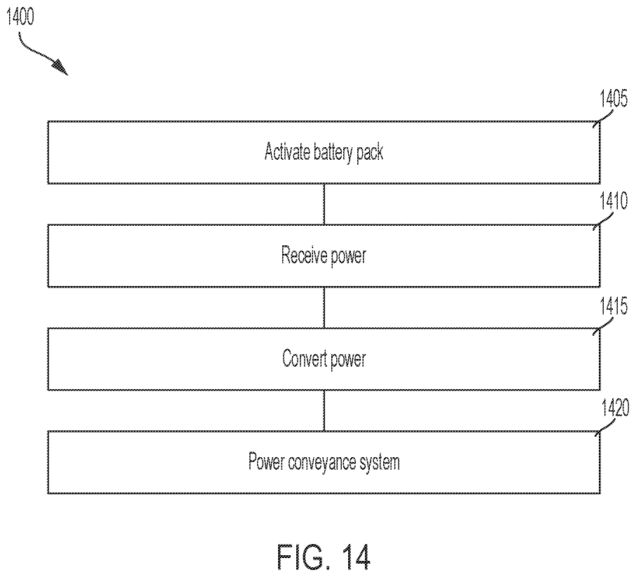

FIG. 14 depicts an example method 1400 of a conveyance system 105. The conveyance system 105 can perform at least one ACT of the method 1400. A component of the conveyance system 105 can perform at least one ACT of the method 1400. For example, the connector 120, the disconnect 125, the emergency stop 180, the converter 130, the motor controller 140, the system controller 145, the motor 150, the user interface 155, the sensor 160, the battery charger 165, the battery 170, or the battery management system 175 can perform at least one ACT of the method 1400 or a portion of at least one ACT of the method 1400. The method 1400 can include an ACT 1405 of activating a battery pack. The method 1400 can include an ACT 1410 of receiving power. The method 1400 can include an ACT 1415 of converting power. The method 1400 can include an ACT 1420 of powering the conveyance system 105.

At ACT 1405, the method 1400 can include activating a battery pack. The conveyance system 105 can connect to the battery pack 115 via the connector 120. The ACT 1405 can include activating the battery pack 115. For example, the battery management system 175 can send, transmit, communicate, or convey a command, request, data packet, data element to instruct the battery pack 115 to turn on, activate, or otherwise convey power from the battery pack 115 to the conveyance system 105. A battery management system of the battery pack 115 can receive the command from the battery management system 175 of the conveyance system 105 and operate at least one switch, contactor, relay, triac, or other component to cause the battery pack 115 to discharge stored chemical energy to provide electrical power to the conveyance system 105. In some examples, responsive to connecting with the conveyance system 105, the battery pack 115 can automatically activate.

Because the battery pack 115 may be not activated to provide power when it is first connected to the conveyance system 105, the conveyance system 105 can be powered based on backup power. The battery 170 can provide backup power to components of the conveyance system 105. For example, the battery 170 can provide backup power to the battery management system 175. The battery management system 175 can generate the command to activate the battery pack 115 and transmit the command to the battery pack 115 based on the backup power received from the battery 170. The backup power of the battery 170 can be based on power received from another battery pack 115. For example, the conveyance system 105 can be connected to a first battery pack 115 and charge the battery 170 based on the power received from the first battery pack 115. When the first battery pack 115 is disconnected from the conveyance system 105, e.g., when it is installed in the vehicle 110, the battery 170 can provide backup power to the components of the conveyance system 105 and enable the battery management system 175 to activate a second battery pack 115 when the second battery pack 115 is connected to the conveyance system 105.

At ACT 1410, the method 1400 can include receiving power. The ACT 1410 can include receiving power from the battery pack 115. The battery pack 115 can provide power to the conveyance system 105 responsive to the battery pack 115 being activated by the battery management system 175. At least one connector 120 can make at least one electrical connection with the battery pack 115. The connector 120 can receive power from the battery pack 115. The connector 120 can receive the power from the battery pack 115 via one or more cables, connectors, or other electrically conducting elements or components. The connector 120 can provide the received power to the converter 130 of the conveyance system 105.

At ACT 1415, the method 1400 can include converting power. The ACT 1415 can include converting the power received from the connector 120 by the converter 130 or the battery charger 165. The converter 130 can convert a voltage level of a signal received from the battery pack 115 from a first level to a second level. The converter 130 can increase the voltage level or reduce the voltage level. For example, the converter 130 can reduce a voltage level of the battery pack 115 to a voltage level that components of the conveyance system 105 can operate on or use. For example, the converter 130 can convert 450V DC to 24V DC.

At ACT 1420, the method 1400 can include powering a conveyance system. The ACT 1420 can include powering the conveyance system 105. For example, the converter 130 can convert power from a first voltage level, e.g., 450V DC, to a second voltage level, e.g., 24V DC. The converter 130 can provide power at the second voltage level to various components of the conveyance system 105 via electrical connections to power the components. For example, the converter 130 can provide power to the motor controller 140, the motor 150, the system controller 145, the user interface 155, the sensor 160, the battery management system 175. The battery charger 165 can include a second converter. The converter of the battery charger 165 can convert power from a first voltage level, e.g., 450V DC, to a second voltage level, e.g., 12V DC. The battery charger 165 can use the power at the second voltage level to charge the battery 170. The battery charger 165 can control a current level provided to the battery 170 or control a voltage level applied to the battery 170. Furthermore, the battery charger 165 can control at least one switch or other component to cause the battery 170 to charge or discharge.

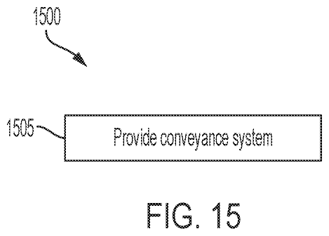

FIG. 15 depicts an example method 1500 of providing a conveyance system. The method 1500 can include an ACT 1505 of providing a conveyance system. The ACT 1505 can include providing the conveyance system 105. The conveyance system 105 can include a connector 120 that connects with the battery pack 115 of the vehicle 110 that is being assembled or manufactured. The connector 120 can make electrical connections with the battery pack 115, for example, at least one electrical connection to receive power from the battery pack 115 and at least one electrical connection to communicate with the battery pack 115. The connector 120 can receive power from the battery pack 115. An emergency stop 180 of the conveyance system 105 can complete a circuit between the connector 120 and other components of the conveyance system 105, such as the converter 130. Responsive to the emergency stop 180 being activated by a user, the emergency stop 180 can break an electrical connection between the battery pack 115 and the conveyance system 105, for example, between the connector 120 and the converter 130.

The converter 130 can convert a voltage level of the battery pack 115 to a voltage level that components of the conveyance system 105 operate on. For example, the motor controller 140 can receive power from the converter 130 and cause at least one motor 150 to turn forwards or turn in reverse. The motor controller 140, based on the power received from the converter 130, can operate the motor 150 to drive the conveyance system 105 forward, drive the conveyance system 105 in reverse, turn the conveyance system 105, park the conveyance system 105, brake the conveyance system 105. The motor 150 can be powered by power received from the converter 130. Furthermore, the converter 130 can provide power to the system controller 145. The system controller 145 can make operating decisions for the conveyance system 105. For example, the system controller 145 can use sensor detections received from the sensor 160 and user input received from the user interface 155 to make driving, braking, or turning decisions for the conveyance system 105. The system controller 145 can communicate the decisions to the motor controller 140 and the motor controller 140 can operate the motor 150 to implement the decisions.

Furthermore, the converter 130 can provide power to the battery charger 165. The battery charger 165 can use the received power to charge the battery 170. The battery 170 can provide backup power to the conveyance system 105 and allow the conveyance system 105 to operate even when the battery pack 115 is disconnected from the conveyance system 105. For example, after a battery pack 115 is disconnected form the conveyance system 105, a battery management system 175 of the conveyance system 105 can received backup power from the battery 170 can transmit commands to a new battery pack 115 to activate the new battery pack 115 and cause the new battery pack 115 to operate to provide power to the conveyance system 105.

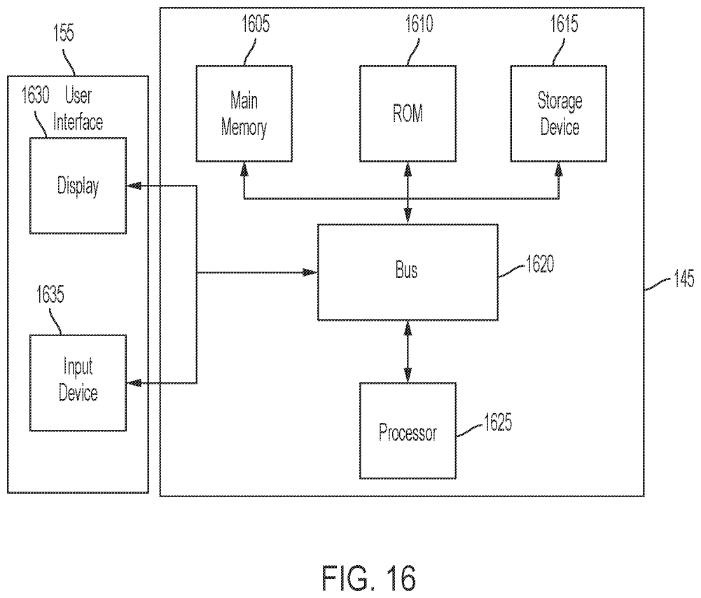

FIG. 16 depicts an example block diagram of a data processing system 145. The data processing system 145 can be a data processing system of the conveyance system 105, such as the system controller 145, the user interface 155, the sensor 160, the motor controller 140, the battery charger 165, or the battery management system 175. The data processing system shown in FIG. 16 can further be a data processing system of the battery pack 115 or a data processing system of the vehicle 110. The data processing system 145 can be a component of a vehicle, a component of a smartphone, a component of a tablet, a component of a laptop computer.

The data processing system 145 can include or be used to implement a data processing system or its components. The data processing system 145 can include at least one bus 1620 or other communication component for communicating information and at least one processor 1625 or processing circuit coupled to the bus 1620 for processing information. The data processing system 145 can include one or more processors 1625 or processing circuits coupled to the bus 1620 for processing information. The data processing system 145 can include at least one main memory 1605, such as a random access memory (RAM) or other dynamic storage device, coupled to the bus 1620 for storing information, and instructions to be executed by the processor 1625. The main memory 1605 can be used for storing information during execution of instructions by the processor 1625. The data processing system 145 can further include at least one read only memory (ROM) 1610 or other static storage device coupled to the bus 1620 for storing static information and instructions for the processor 1625. A storage device 1615, such as a solid state device, magnetic disk or optical disk, can be coupled to the bus 1620 to persistently store information and instructions.

The data processing system 145 can be coupled via the bus 1620 to a display 1630 of the user interface 155. The display 1630 can be a liquid crystal display or active matrix display. The display 1630 can display information to a user such as an operator of the conveyance system 105. An input device 1635 of the user interface 155, such as a keyboard or voice interface can be coupled to the bus 1620 for communicating information and commands to the processor 1625. The input device 1635 can include a touch screen of the display 1630. The input device 1635 can include a cursor control, such as a mouse, a trackball, or cursor direction keys, for communicating direction information and command selections to the processor 1625 and for controlling cursor movement on the display 1630.

The processes, systems and methods described herein can be implemented by the data processing system 145 in response to the processor 1625 executing an arrangement of instructions contained in main memory 1605. Such instructions can be read into main memory 1605 from another computer-readable medium, such as the storage device 1615. Execution of the arrangement of instructions contained in main memory 1605 causes the data processing system 145 to perform the illustrative processes described herein. One or more processors in a multi-processing arrangement can be employed to execute the instructions contained in main memory 1605. Hard-wired circuitry can be used in place of or in combination with software instructions together with the systems and methods described herein. Systems and methods described herein are not limited to any specific combination of hardware circuitry and software.

Although an example computing system has been described in FIG. 16, the subject matter including the operations described in this specification can be implemented in other types of digital electronic circuitry, or in computer software, firmware, or hardware, including the structures disclosed in this specification and their structural equivalents, or in combinations of one or more of them.

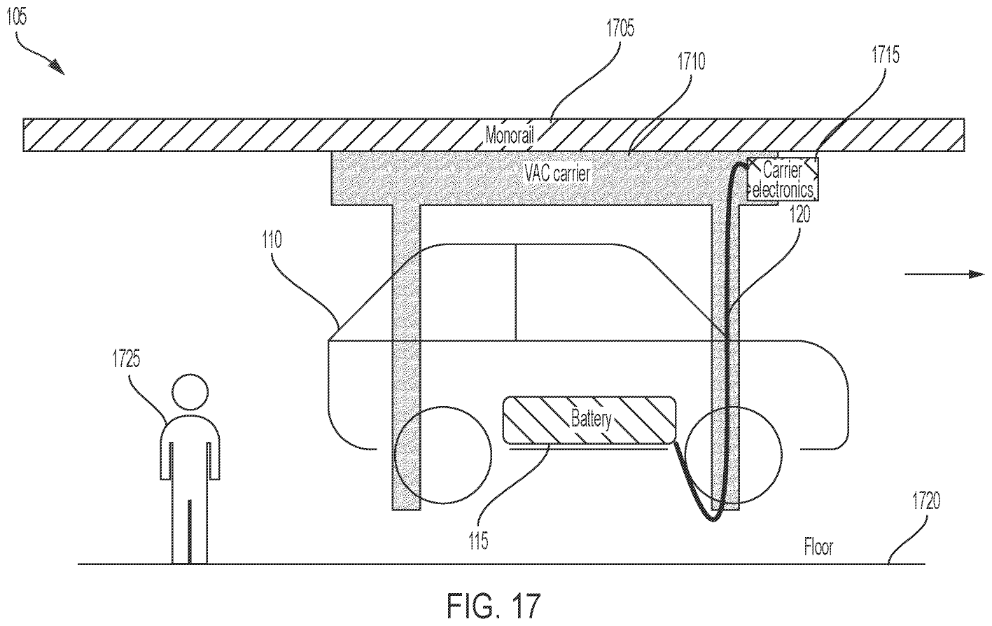

FIG. 17 depicts an example VAC 105 powered by a battery pack 115 of a vehicle 110 carried by the VAC 105 from a side view. The VAC 105 can include at least one rail or a monorail 1705. A VAC carrier or conveyor 1710 of the VAC 105 can be fixed, coupled, or attached to the rail 1705. The VAC carrier 1705 can travel along the rail 1705 forwards or backwards. The VAC carrier 1710 can include at least one arm that couples to, supports, carries, of attaches to the vehicle 110. The VAC carrier 1710 can suspend the vehicle 110 over a floor, ground surface, pavement, dirt, or any other surface 1720. A connector or power cable 120 can connect at least one carrier electronic component 1715 to the battery pack 115. The cable 120 can extend from the carrier electronics 1715 through an arm of the VAC carrier 1710 to electrically connect or couple to the vehicle 110 or the battery pack 115. A person, such as a manufacturing individual 1725, can assemble, manufacture, or repair the vehicle 110 while the vehicle 110 is transported by the VAC 105.

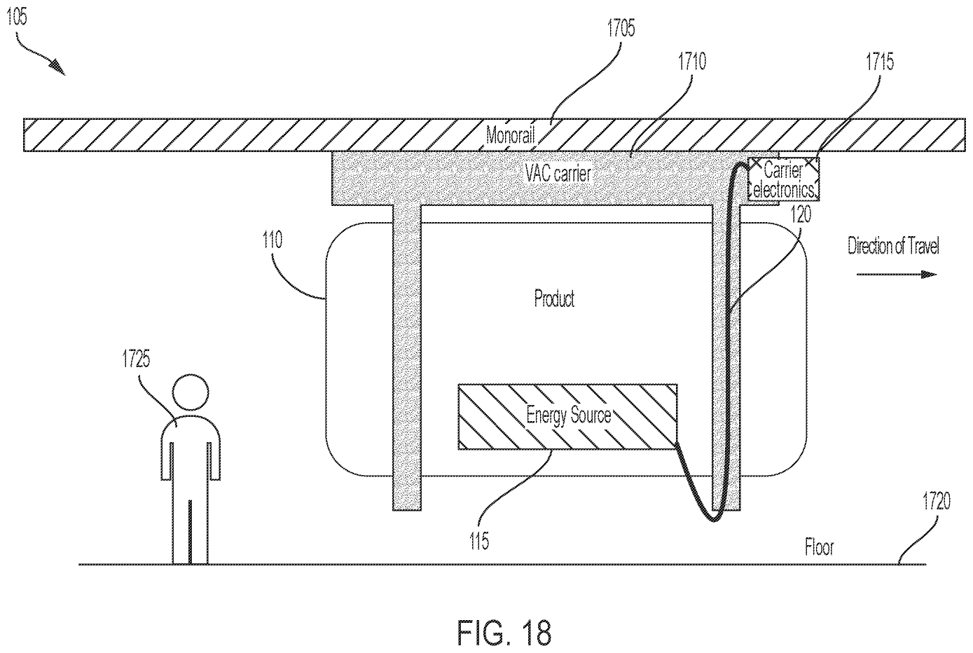

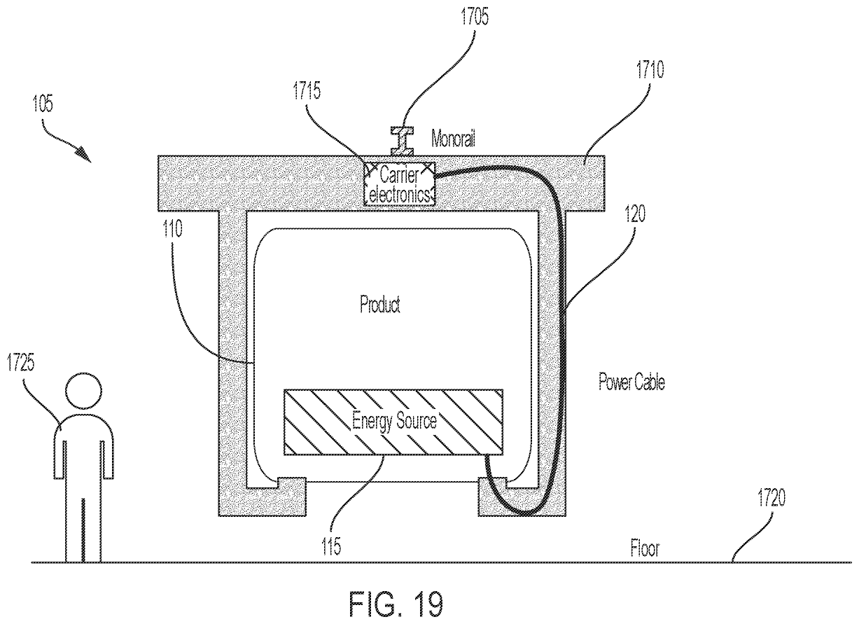

The carrier electronics 1715 can receive power from the battery 115 via the cable 120. The carrier electronics 1715 can include the disconnect 125, the emergency stop 180, the converter 130, the fuses 135A or 135B, the motor controller 140, the motor 150, the system controller 145, the user interface 155, the sensor 160, the battery charger 165, the battery 170, or the battery management system 175. The carrier electronics 1715 can include components that translate, transport, or cause VAC carrier 1710 to move forward or backwards on the rail 1705. While a vehicle 110 is shown in FIG. 17 to be carried by the VAC carrier 1720, any product 110 can be carried by the VAC carrier 1710, e.g., as shown in FIG. 18. The product can be a truck, a car, an airplane, a sedan, an automobile, a submarine, a ship, a boat, an all-terrain vehicle, a wheel chair, a motorcycle, or any other product powered by a power source 115. An energy source 115 of the product 110 can provide power to the carrier electronics 1720 through the cable 120. FIG. 19 depicts the VAC 105 powered by the energy source 110 of the product 110 carried by the VAC 105 from a front view.

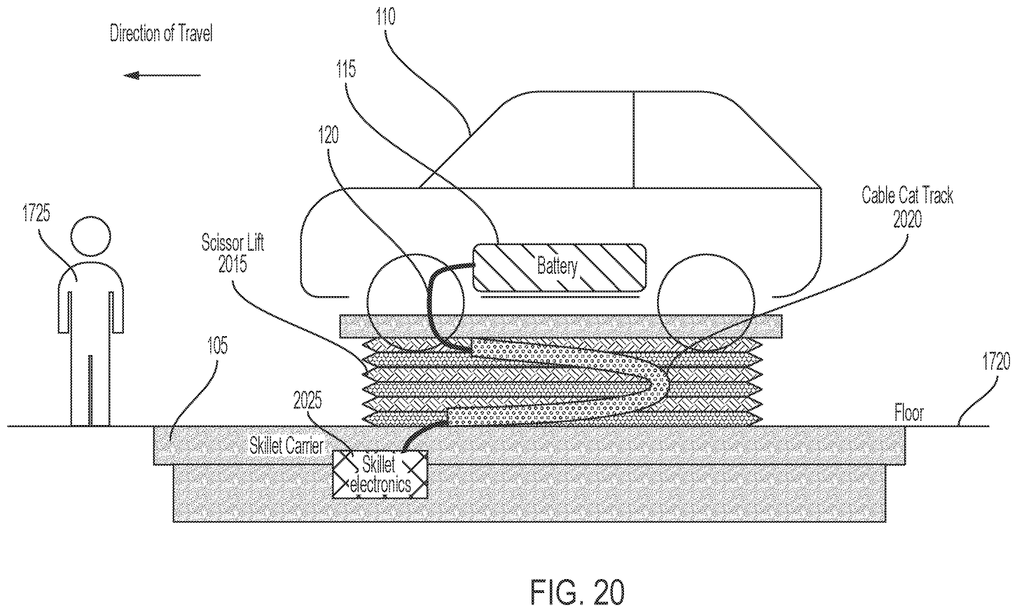

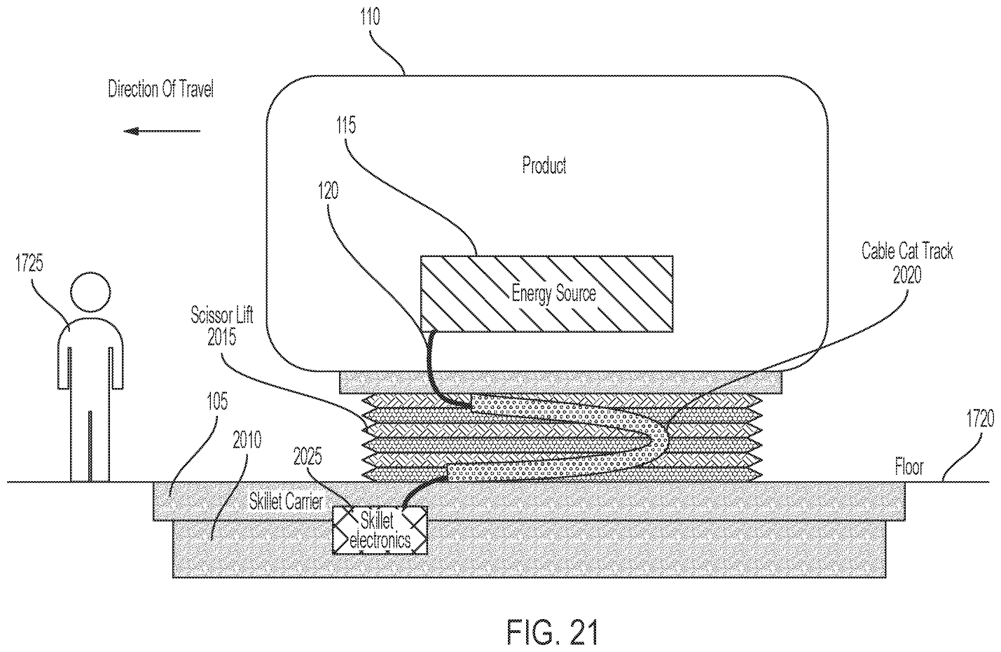

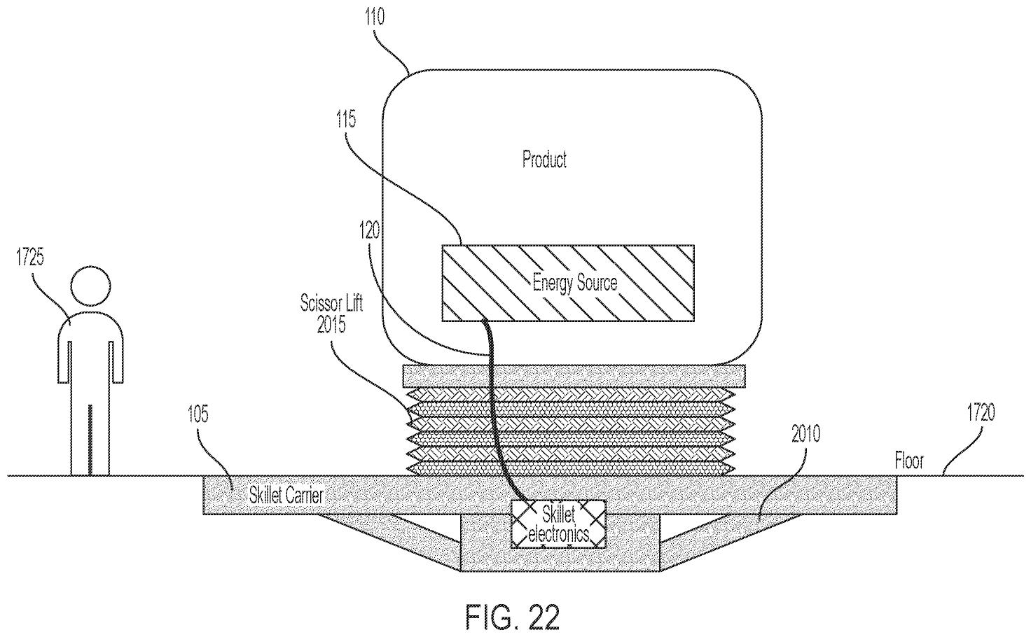

FIG. 20 depicts an example skillet carrier 105 powered by a battery pack 115 of a vehicle 110 carried by the skillet carrier 105 from a side view. The skillet carrier 105 can be located under a floor 1720. A lift, such as a scissor lift or conveyor 2015, can support, lift, hold the vehicle 110 and the battery pack 115 above the floor 1720. The skillet carrier 105 can move forward, backwards, or turn based on power received from the battery 115. The skillet carrier 105 can include skillet electronics 2025. The skillet electronics 2025 can receive power from the battery 115 via the cable 120 which can extend through a cable cat track 2020. The carrier electronics 1715 can include the disconnect 125, the emergency stop 180, the converter 130, the fuses 135A or 135B, the motor controller 140, the motor 150, the system controller 145, the user interface 155, the sensor 160, the battery charger 165, the battery 170, or the battery management system 175. While a vehicle 110 is shown in FIG. 20 to be carried by the skillet carrier 105, any product 110 can be carried by the skillet carrier 105, e.g., as shown in FIG. 21. FIG. 22 depicts the skillet carrier 105 powered by the energy source 110 of the product 110 carried by the skillet carrier 105 from a front view.

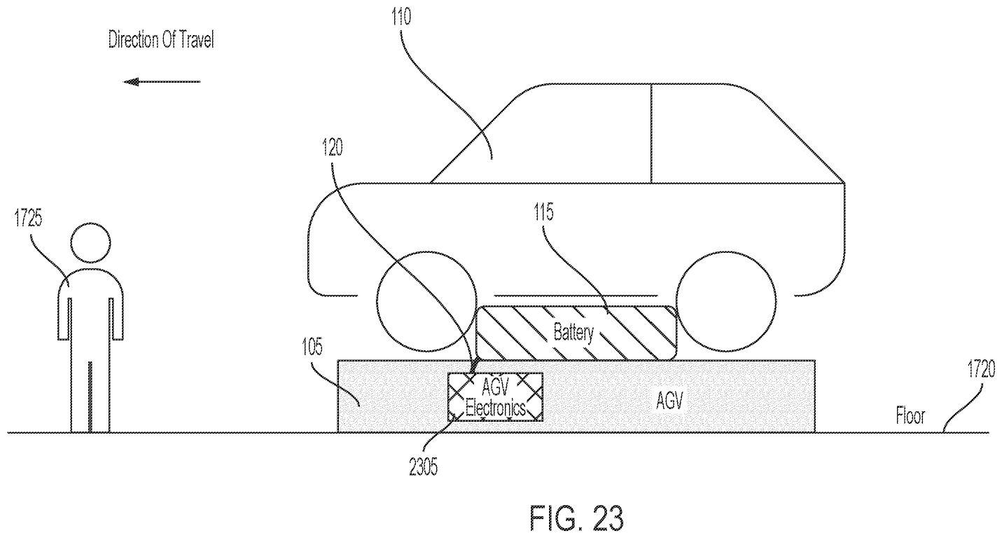

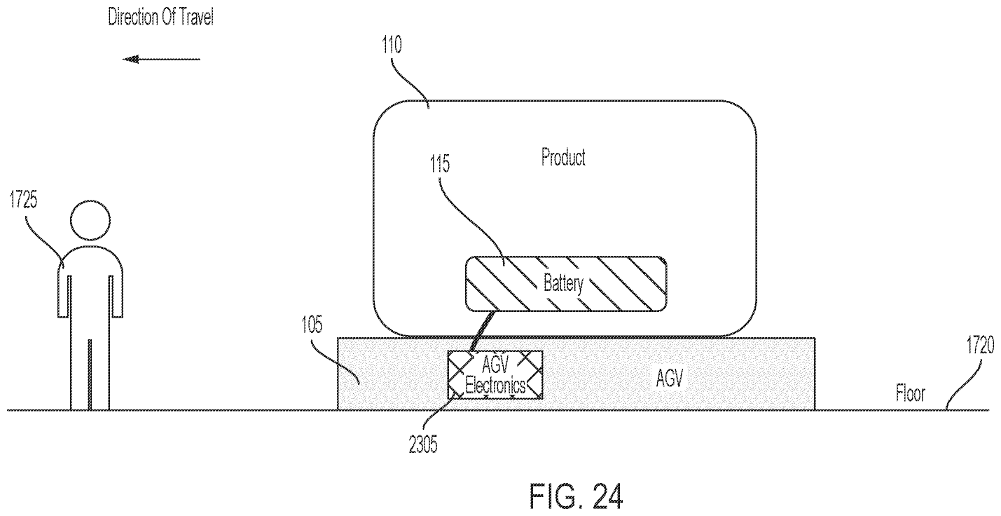

FIG. 23 depicts an example AGV 105 powered by a battery pack 115 of a vehicle 110 carried by the AGV from a side view. The vehicle 110, or a portion of the vehicle 110, in either a fully assembled or partially assembled state, can rest on a top surface of the AGV 105. The AGV can connect to the battery pack 115 through a cable 120. The battery 115 can provide power to AGV electronics 2305 via the cable 120. The AGV electronics 2305 can include the disconnect 125, the emergency stop 180, the converter 130, the fuses 135A or 135B, the motor controller 140, the motor 150, the system controller 145, the user interface 155, the sensor 160, the battery charger 165, the battery 170, or the battery management system 175. The AGV 105 can travel along the floor 1720 based on tractive components powered or operated based on power received from the battery pack 115. For example, motors, wheels, conveyor belts, or other components can transport the AGV 105. While a vehicle 110 is shown in FIG. 23 to be carried by the AGV 105, any product 110 can be carried by the AGV 105, e.g., as shown in FIG. 24.

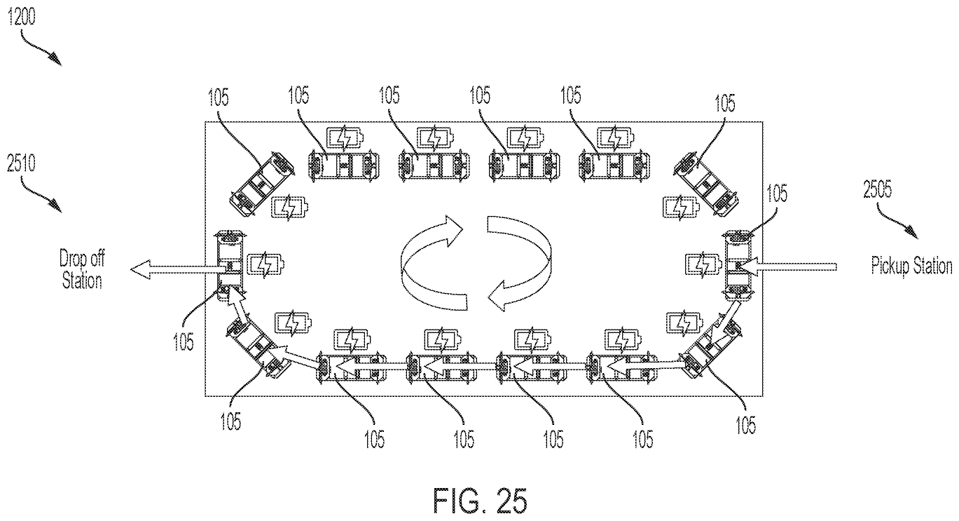

FIG. 25 depicts an assembly environment 1200 where conveyance systems 105 charge at assembly stations. The conveyance systems 105 can include on-board batteries that power the conveyance systems 105 from assembly station to assembly station within the assembly environment 1200, e.g., within a loop. At a pickup station 2505, a product, such as a vehicle or a component of a vehicle, can be placed onto, coupled with, or otherwise connected to the conveyance system 105 as the conveyance system 105 moves from assembly station to assembly station where assembly actions are performed. When the conveyance system 105 reaches the drop off station 2510, the product can be removed from the conveyance system. At one or multiple stations or stopping areas, the conveyance system 105 can connect to a charging infrastructure to charge the internal batteries of the conveyance system. The stations can have charging infrastructure built into all the stations or selected portion of the stations.

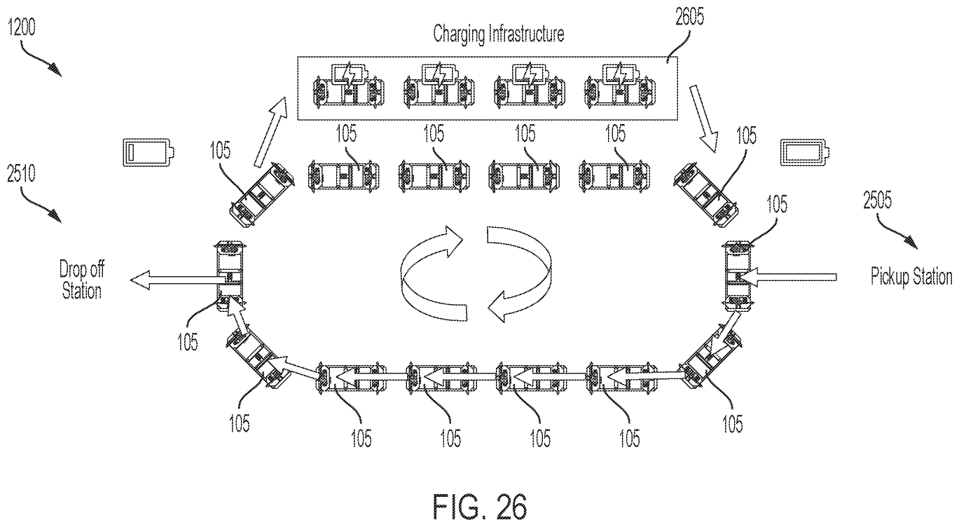

FIG. 26 depicts an assembly environment where conveyance systems 105 charge at charging infrastructure 2605. When the conveyance systems 105 reach the drop off station 2510, the internal batteries of the conveyance system 105 may be fully or partially discharged, e.g., have a charge level less than a particular level. If the internal batteries of the conveyance system 105 has a charge level greater than the particular level, the conveyance system 105 can transport or move to the pickup station 2505 to pick up a new product, or portion of a product, to be assembled or manufactured. If the internal batteries of the conveyance system 105 have a charge level less than the particular level, the conveyance system 105 can exit a loop and transport or move to the charging infrastructure 2605 or an offshoot station area where the internal batteries of the conveyance system 105 can be charged. Once the internal batteries of the conveyance systems 105 are fully charged, or charged above a particular level, the conveyance systems 105 can leave the charging infrastructure 2605 to re-enter the loop and move to the pickup station 2505 to receive a new product or a portion of the product.

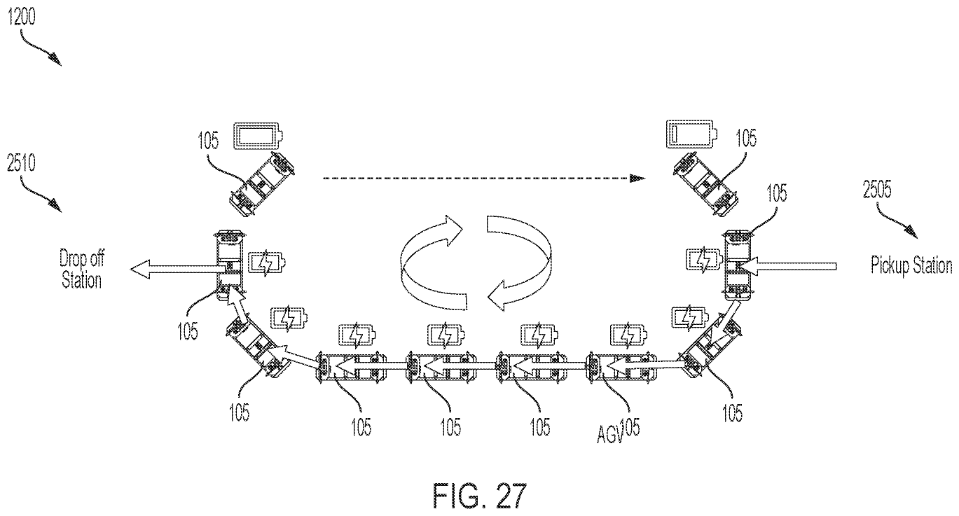

FIG. 27 depicts an assembly environment where conveyance systems 105 are powered based on a battery pack 115 of a vehicle 110 that is being assembled. At the pickup station 2505, the conveyance systems 105 can receive or be connected with a battery pack 115 of a vehicle 110 or other product that is being assembled or manufactured. The conveyance systems 105 can receive power from the battery packs 115 and operate based on, or utilize, the power received from the battery packs 110. The conveyance systems 105 can use the power received from the battery packs 115 to transport from the pickup station 2505 to the drop off station 2510. The conveyance systems 105 can be discrete carriers that utilize energy supplied by a battery payload during conveyance. The conveyance systems 105 can charge, or continuously charge, internal batteries of the conveyance systems 105 based on the power received from the battery packs 115 as the conveyance systems 105 moves through the environment 1200. When the conveyance systems 105 reach the drop off station 2510, the conveyance systems 105 can be disconnected from the battery packs 110. The conveyance systems 105 can operate based on the power of the internal battery to transport or move the conveyance systems 105 from the drop off station 2510 back to the pickup station 2505 without a battery pack 115. Once the conveyance system 105 reaches the pickup station 2505, the conveyance system 105 can receive a new battery pack 115.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The conveyance system described herein is powered by a battery pack of a vehicle that is being manufactured or assembled. However, these techniques can be applied to other conveyance systems outside of manufacturing or assembly. For example, a car wash may connect with a manufactured or assembled vehicle and convey the vehicle through the car wash based on power received from a battery pack of the car wash. Similarly, any maintenance or service environment for servicing assembled or manufactured vehicles can include a conveyance system that moves the vehicles throughout the environment based on power received from the vehicles. A vehicle delivery system that transports one or multiple vehicles from one location to another (e.g., from a factory to a customer or from a factory to a dealership) can connect to at least one manufactured or assembled vehicle and be powered based on power received from the vehicles that the vehicle delivery system transports. Similarly, a ferry, a semi-truck, a trailer, or any other component that can carry or transport a vehicle can receive power from the vehicle and operate (e.g., power electronics, power motors, power lights) based on the received power.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a conveyor to transport at least a portion of a vehicle;
a connector to electrically couple an energy source of the vehicle with the conveyor; and
a voltage converter to convert power from the energy source to operate the conveyor to transport at least the portion of the vehicle.

2. The system of claim 1, comprising:
the voltage converter to:
reduce voltage from a first voltage level received from the energy source to a second voltage level to be used by a component of the conveyor.

3. The system of claim 1, comprising:
the voltage converter to:
provide the power to at least one of a controller, a human-machine interface, or a sensor of the conveyor.

4. The system of claim 1, comprising:
a charger to:
receive the power of the energy source; and
charge a battery of the system based on the power of the energy source; and
the battery to:
provide backup power to the conveyor.

5. The system of claim 1, wherein the system is at least one of an automated guided vehicle, a vertical articulated carrier (VAC), or a skillet conveyor.

6. The system of claim 1, comprising:
the voltage converter to:
convert a 450 volts of direct current received from the energy source to a 24 volts of direct current to power a first component of the conveyor; and
reduce the 24 volts of direct current to 12 volts of direct current to power a second component of the conveyor.

7. The system of claim 1, comprising:
the voltage converter comprising:
a first voltage converter to reduce voltage from a first voltage level received from the energy source to a second voltage level; and
a second voltage converter to receive the second voltage level from the first voltage converter and reduce the second voltage level to a third voltage level.

8. The system of claim 1, comprising:
the voltage converter comprising a first voltage converter to:
reduce voltage from a first voltage level received from the energy source to a second voltage level; and
power a first component of the conveyor with the second voltage level; and
the voltage converter comprising a second voltage converter to:
receive the second voltage level from the first voltage converter and reduce the second voltage level to a third voltage level; and
power a second component of the conveyor with the third voltage level.

9. A method, comprising:
receiving, by a connector, power from a battery pack of a vehicle;
converting, by a voltage converter, the power from the battery pack for a conveyor; and
operating the conveyor based on the converted power to assemble at least a portion of the vehicle.

10. The method of claim 9, comprising:
connecting to the battery pack to receive the power from the battery pack;
charging a battery of the conveyor;
disconnecting from the battery pack;
connecting to a second battery pack; and
transmitting a command to the second battery pack to activate the second battery pack, wherein the command is transmitted based on the power of the battery.

11. The method of claim 9, comprising:
reducing, by the voltage converter, a voltage from a first voltage level received from the battery pack to a second voltage level to be used by at least one component of the conveyor.

12. The method of claim 9, comprising:
providing the power to at least one of a controller, a human-machine interface, or a sensor of the conveyor.

13. The method of claim 9, comprising:
receiving, by a charger, the power of the battery pack from the voltage converter;
charging, by the charger, a battery based on the power of the battery pack received from the voltage converter; and
providing, by the battery, backup power to components of the conveyor.

14. The method of claim 9, comprising:
converting, by a first voltage converter of the voltage converter, voltage from a first voltage level received from the battery pack to a second voltage level; and
reducing, by a second voltage converter of the voltage converter, the second voltage level to a third voltage level.

15. The method of claim 9, comprising:
converting, by the voltage converter, a 450 volts of direct current received from the battery pack to a 24 volts of direct current to power a first component; and
reducing, by the voltage converter, the 24 volts of direct current to 12 volts of direct current to power a second component.

16. A vehicle, comprising:
a frame to carry a battery pack for an automobile;
a connector to electrically couple the battery pack with the vehicle; and
a voltage converter to convert power from the battery pack to operate the vehicle to assemble at least a portion of the automobile.

17. The vehicle of claim 16, comprising:
the voltage converter, comprising:
a first voltage converter to convert a first power level from the battery pack to a second power level; and
a second voltage converter to convert the second power level to a third power level, the second power level and the third power level to operate the vehicle.

18. The vehicle of claim 16, wherein the vehicle is an automated guided vehicle.

19. The vehicle of claim 16, comprising:
a charger to:
receive the power of the battery pack from the voltage converter; and
charge a battery based on the power of the battery pack; and
the battery to provide backup power to the vehicle.

20. The vehicle of claim 16, comprising:
an input device to:
receive an input from a user; and
electrically disconnect the battery pack from the vehicle responsive to a reception of the input.
